(19) United States
(12) Patent Application Publication
(10) Pub. No.: US 2024/0363294 A1
(43) Pub. Date: Oct. 31, 2024

(54) Posture-Adaptive Keyboard

(71) Applicant: Keahi Chun, Honolulu, HI (US)

(72) Inventor: Keahi Chun, Honolulu, HI (US)

(73) Assignee: LabeL Free LLC, Honolulu, HI (US)

(21) Appl. No.: 18/644,376

(22) Filed: Apr. 24, 2024

Related U.S. Application Data
(60) Provisional application No. 63/462,924, filed on Apr. 28, 2023.
(60) Provisional application No. 63/465,235, filed on May 9, 2023.

(51) Int. Cl. H01H 13/84; H01H 13/10

(52) U.S. Cl. CPC H01H 13/84; H01H 13/10; H01H 2217/044

(57) ABSTRACT

The Posture-Adaptive Keyboard enhances user-computer interactions through dynamic three-dimensional adjustability—horizontally, vertically, and angularly. It features an enclosure made from materials including opaque, translucent, or transparent options, and incorporates a versatile mounting mechanism. This design allows the keyboard to align with the user's natural ergonomic posture, potentially reducing repetitive stress injuries (RSIs). A key feature is the variable friction articulated arm connected to the keyboard's integrated mounting mechanism, which permits precise and stable positioning. Adjustments are made via a friction control knob, optimizing ergonomic settings for user comfort. The keyboard supports both wired and wireless setups, ensuring compatibility with various computing environments. Designed to offer dynamic adjustability and user-centric customization, the Posture-Adaptive Keyboard aims to improve user well-being and productivity, representing a significant advancement in ergonomic computing peripherals.

### FIELD OF INVENTION

This invention pertains to the technical field of ergonomic computer peripherals, focusing specifically on a keyboard that dynamically conforms to the user's preferred posture. It introduces an approach to ergonomic keyboard configuration that emphasizes dynamic adjustability in three dimensions—horizontally, vertically, and angularly—to align with the user's natural posture, thereby promoting comfort and mitigating the risk of repetitive strain injuries (RSIs). This keyboard integrates seamlessly with a variety of support mechanisms, including variable friction articulated arms and mounts, to offer unmatched adaptability in positioning. It accommodates both wired and wireless setups, ensuring compatibility across different user environments and computing systems. This invention addresses the urgent need for personalizable ergonomic computer peripherals that actively contribute to the user's health and productivity by providing a customizable typing experience that aligns with natural body posture.

### BACKGROUND OF INVENTION

The journey towards ergonomic enhancements in computing peripherals has increasingly focused on mitigating the risks associated with repetitive stress injuries (RSIs) by advocating for devices that accommodate the user's natural posture. Despite technological advances, the design paradigm for computer keyboards has seen minimal evolution, with the majority adhering to a static, flat configuration that rests parallel to the desk surface. This traditional flat design necessitates users to conform their posture to the keyboard, requiring pronation of the wrists—a position known to contribute to discomfort, musculoskeletal health problems, and a heightened risk of RSIs over prolonged periods of use.

The rise of digital work environments, accelerated by trends such as remote working and extensive gaming sessions, has further underscored the need for more adaptive and health-oriented computing setups. Ergonomic research has highlighted the critical need for adaptable work environments that respect the physiological diversity of users, suggesting that peripherals, such as keyboards, should offer greater positioning flexibility. While strides have been made in introducing adjustability into certain computer peripherals, there is a conspicuous absence of keyboard designs that fully embrace adjustability in three key dimensions: height, depth, and angle. Such comprehensive adjustability is essential to ensure that a keyboard can be aligned with an individual's specific ergonomic requirements.

The gap between existing ergonomic strategies and their practical application in keyboard design underlines a pressing need for innovation in this area. An optimal solution would provide users with the ability to dynamically adjust their keyboard's positioning, catering to their unique physical needs and working preferences. By introducing a design that facilitates such versatility, the aim is to enhance both user comfort and productivity, while also contributing to the prevention of RSIs, thereby addressing a long-standing issue in the realm of ergonomic computing peripherals.

### SUMMARY OF INVENTION

The present invention introduces a Posture-Adaptive Keyboard designed to significantly enhance ergonomic interaction between the user and their computing environment. Central to this innovation is the keyboard's capability for dynamic adjustability in three dimensions—horizontally (x-axis), vertically (y-axis), and angularly (z-axis). This adjustability allows users to customize their typing posture to one that is most natural and comfortable for them, using support mechanisms such as variable friction articulated arms and versatile mounting options. These features enable the keyboard to be optimally positioned in relation to the user's body posture.

Key features of the invention include:

1. A keyboard enclosure made from materials ranging from opaque to transparent, providing both aesthetic choices and ergonomic benefits. The enclosure is equipped with a mounting mechanism for straightforward attachment to and detachment from various support structures.

2. A variable friction articulated arm and other adjustable supports that facilitate precise positioning of the keyboard across all three dimensions. This is essential for ergonomic adaptability to diverse user needs and workspace environments.

3. Compatibility with both wired and wireless configurations, ensuring seamless integration into various computing setups and including accommodations for data and power transfer tailored to different user requirements.

The Posture-Adaptive Keyboard is designed to offer a highly customizable typing experience that aligns with individual ergonomic needs, aiming to reduce the risk of repetitive stress injuries and other musculoskeletal conditions commonly associated with traditional keyboard use. This invention enhances user comfort and productivity by providing a functionally adaptive and ergonomically optimized keyboard solution.

### BRIEF DESCRIPTION OF DRAWINGS

The figures provided herein illustrate various embodiments of the Posture-Adaptive Keyboard, offering perspectives on its design, components, and functional adaptability. Brief descriptions of the figures are as follows:

FIG. 1-FIG. 8: These figures provide various perspectives of the Posture-Adaptive Keyboard and its enclosure which may be attached to a variety of support structures via its mounting mechanism for enhanced positional adjustability. The keyboard in these illustrations showcase the right hand portion of a split keyboard using QWERTY-keyboard-layout keycaps commonly used for computing in the United States.

FIG. 9-FIG. 16: These figures provide various perspectives of a second embodiment of the Posture-Adaptive Keyboard, each illustrating the integration with a variable friction articulated arm for enhanced positional adjustability.

FIG. 17: An exploded view detailing the detachable connection between the keyboard and the articulated arm, showcasing the ease of assembly and adjustment.

FIG. 18-FIG. 25: These figures exhibit additional embodiments showing the keyboard attached to different support structures like clamps, stands, and extendable stands, illustrating the versatility in positioning the keyboard for optimal ergonomic alignment.

FIG. 26-FIG. 29: Focus on embodiments where the keyboard is attached to furniture-specific fixture-tracks, such as those found on chairs and desks, highlighting the adaptability of the keyboard to various user environments.

FIG. 30-FIG. 39: Provide detailed views of the fixture-track, an attachment mechanism compatible with an articulated arm for furniture surface integration.

FIG. 40: An exploded close-up view illustrating the precise assembly of the keyboard's articulated arm to a fixture-track, showcasing the detailed components and their functionality.

### DETAILED DESCRIPTION OF PREFERRED EMBODIMENTS

In the following detailed description of the subject matter hereof, one or more preferred embodiments are illustrated with certain specific details of implementation. However, it will be recognized by one skilled in the art that many other variations and modifications may be made and/or practiced in analogous applications or environments. It should be noted that methods, procedures, components, or functions that are commonly known to persons of ordinary skill in the field of the invention are not described in detail herein so as to avoid unnecessarily obscuring a concise description of the preferred embodiment.

### Overview of the Invention

The present disclosure introduces the Posture-Adaptive Keyboard, an ergonomic computing device designed to dynamically conform to the user's preferred ergonomic posture. This invention features a keyboard enclosure that supports adjustability in three-dimensional space—horizontally (x-axis), vertically (y-axis), and angularly (z-axis)—to promote optimal ergonomic health and enhance user productivity. The adjustable nature of the keyboard is facilitated by a mounting mechanism incorporated into the keyboard enclosure, which allows for secure attachment and precise positioning via a variable friction articulated arm, an articulating assembly, or other suitable support structures.

An integral part of a preferred embodiment of this invention is the articulating assembly, which facilitates the three-dimensional adjustability of the keyboard. This assembly consists of a series of interconnected components that enable the keyboard to move horizontally (x-axis), vertically (y-axis), and angularly (z-axis). The articulating assembly includes, but is not limited to, joints such as elbows and wrists that allow for complex movements. Each joint can be locked or adjusted in tension to maintain a desired position, making it possible to precisely control the angle, height, and extension of the keyboard relative to the user. This capability is critical for tailoring the keyboard's position to meet individual ergonomic needs, enhancing comfort and reducing the risk of repetitive stress injuries.

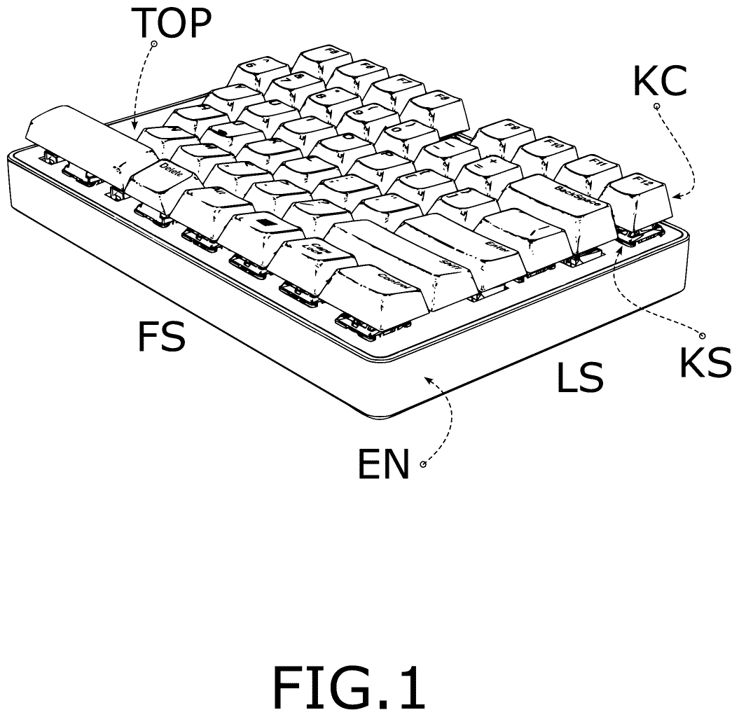

### Detailed Description Corresponding to FIG. 1 through FIG. 8

### FIG. 1: Front-Top-Left Perspective View

Referring to FIG. 1, a preferred embodiment of a Posture-Adaptive Keyboard is shown having a cuboid shaped enclosure EN formed with six sides, i.e., left-side LS, right-side (not visible), front-side FS, back-side (not visible), top-side TOP, and bottom-side (not visible). The enclosure EN may be formed in other configurations besides a cuboid shape, such as a semi-circle, oval, spherical, or polygonal shape. The top-side TOP in this configuration has a metal plate designed to hold keyswitches KS which support the keycaps KC of the keyboard. The enclosure EN may be made of structurally durable, opaque, translucent, or transparent material. Many kinds of durable material such as wood, metal, or composite may be used to form the enclosure EN.

This view displays the preferred embodiment of the Posture-Adaptive Keyboard, highlighting the cuboid-shaped enclosure. The current enclosure material of choice is aluminum, chosen for its robust yet CNC machining qualities. An aluminum enclosure, visible from the front, top, and left angles, has the added renewable advantage which benefits our natural environment in that it can be recycled many times. The material for the keyboard enclosure should be soft enough to cut with a CNC machine but rigid enough to incorporate a mounting mechanism. This material choice not only provides aesthetic flexibility but also contributes to the keyboard's structural integrity. Aluminum tends to fit this bill well. This front-top-left perspective shows the general layout of the keycaps arranged according to the right hand side of the common and popular QWERTY layout of letters and numbers.

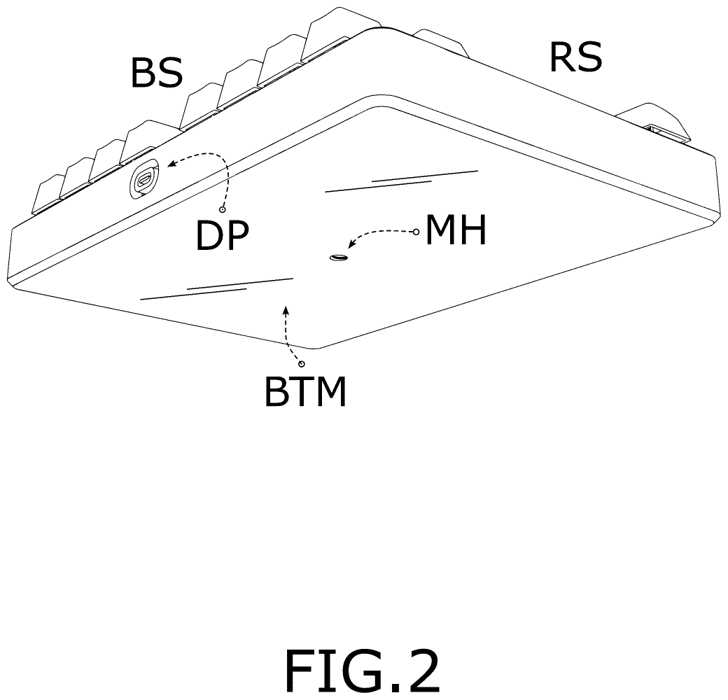

### FIG. 2: Back-Bottom-Right Perspective View

FIG. 2 is a back-bottom-right perspective view of a preferred embodiment of a Posture-Adaptive Keyboard showing a mounting hole MH formed on the bottom-side BTM with both the back-side BS, and right-side RS visible. There is a data-power port DP on the back-side BS for the combined use of transferring data and supplying power to and from the Posture-Adaptive Keyboard.

The back-bottom-right perspective shows where the mounting hole for the articulated arm is situated. The mounting mechanism of this embodiment is a threaded hole standardized to ¼ inch by 20 threads per inch (¼″—20 UNC), allowing for easy attachment of various mounting options that facilitate the keyboard's three-dimensional adjustability. The data-power port, including connectivity options such as USB Type-C, is prominently displayed, highlighting the keyboard's versatility to support both wired and wireless configurations effectively. This port is critical for data transfer and power supply, enhancing the keyboard's versatility in various user setups and adding to the keyboard's capability to integrate seamlessly with various computing systems.

Displaying the keyboard from the back, bottom, and right perspectives, this figure highlights the underside of the enclosure where the mounting hole is prominently featured. Central to this figure is the visibility of the integrated mounting mechanism, a threaded hole strategically located in the bottom of the enclosure in this embodiment.

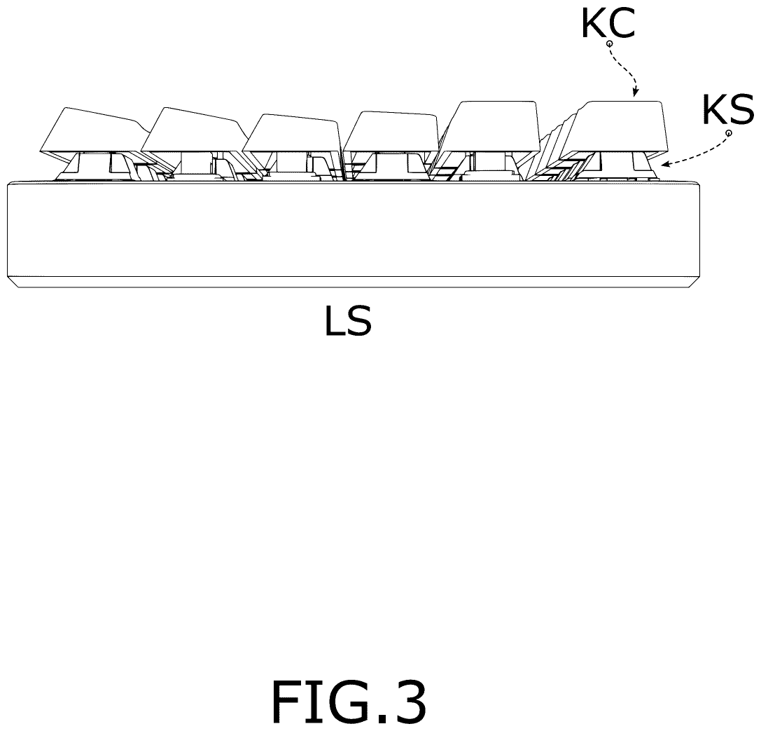

### FIG. 3: Left Perspective View

FIG. 3 is a left perspective view of a preferred embodiment of a Posture-Adaptive Keyboard showing a profile of the keyswitches KS and keycaps KC on the left-side LS.

Illustrating the left side of the keyboard, this view details the arrangement of the keyswitches beneath the keycaps. This side also hints at the internal layout designed to house electronic components compactly, supporting both the wired and wireless operational modes.

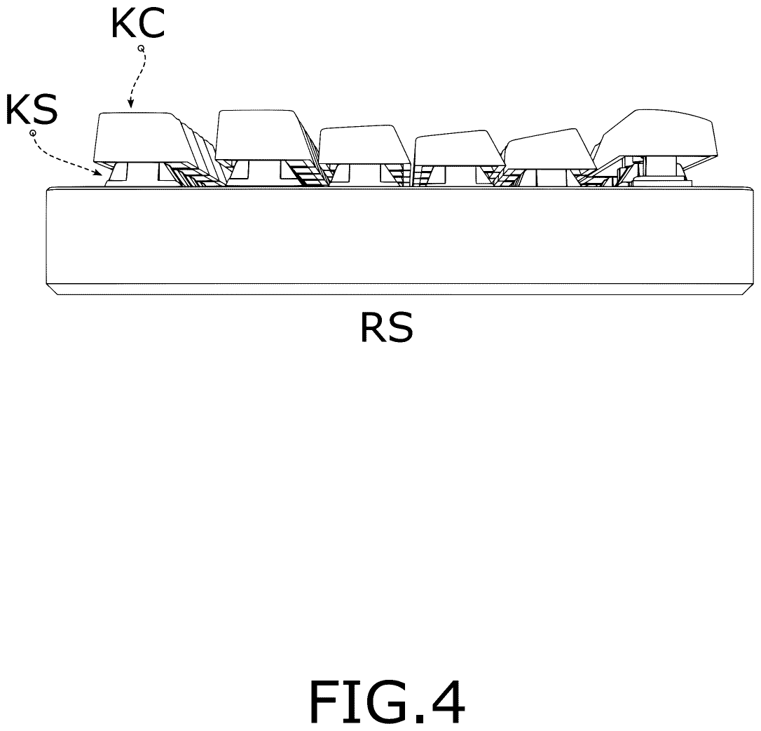

### FIG. 4: Right Perspective View

FIG. 4 is a right perspective view of a preferred embodiment of a Posture-Adaptive Keyboard showing a profile view of the keyswitches KS and keycaps KC on the right-side RS.

Nearly mirroring the left perspective, the right view provides an alternative angle of the mechanical keyswitches and how they sit beneath the keycaps. The keyswitches used for the embodiments in all the figures accompanying this disclosure are of a standardized form known to individuals skilled in the art as “Cherry MX”. Cherry MX switches are characterized by their distinct “+” shaped stem for attaching the keycaps, and a consistent footprint that allows them to be compatible with a wide range of keyboards and keycaps. This keycap profile is not unlike the keycaps used on many traditional mechanical keyboards. Therefore the keypad itself is relatively flat and not central to the concept of what makes this keyboard ergonomic.

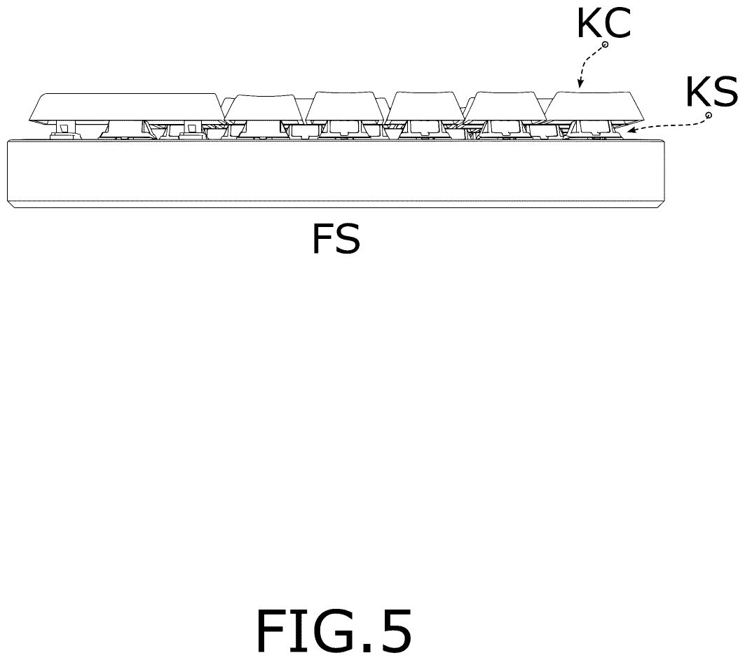

### FIG. 5: Front Perspective View

FIG. 5 is a front perspective view of a preferred embodiment of a Posture-Adaptive Keyboard showing a view of the keyswitches KS and keycaps KC from the front-side FS.

The front view focuses on the user interface area of the keyboard. It showcases the ergonomic placement of keys and any function indicators that are part of the keyboard's design. This perspective is crucial for understanding the user interaction zone and the visual accessibility of the keyboard's features.

Offering a view from the front, this figure shows the keyboard as it would typically be seen by a user during operation. To be clear the focus of the ergonomic innovation of this keyboard is not how the keycaps are distributed but rather the integrated mounting mechanism allowing for the keyboard enclosure's freedom of positioning across all three dimensions.

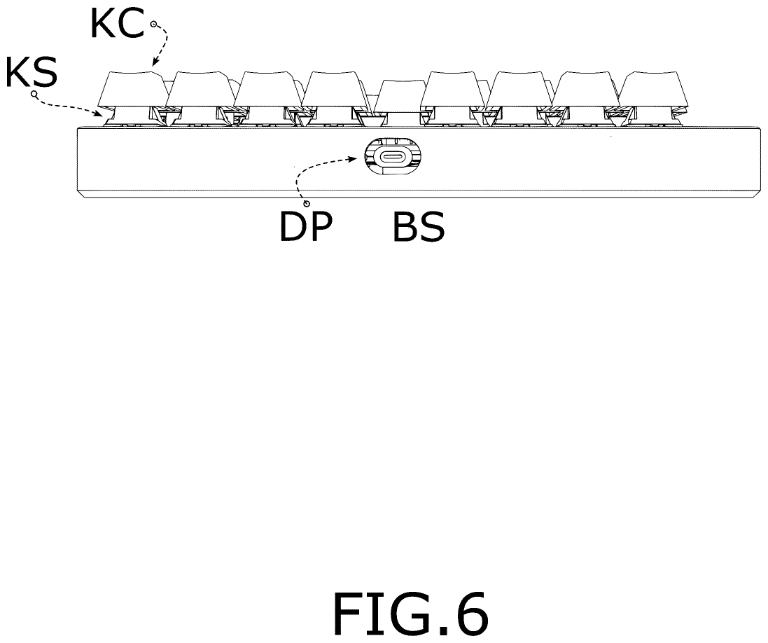

### FIG. 6: Back Perspective View

FIG. 6 is a back perspective view of a preferred embodiment of a Posture-Adaptive Keyboard showing a view of the keyswitches KS and keycaps KC from the back-side BS where a data-power port DP is located for transferring both data and power to and from the conforming keyboard.

From the back, the perspective emphasizes the data-power port arrangement necessary for the keyboard's functionality. This includes details on the integration of ports for power supply and data transfer, which are crucial for both wired and wireless versions of the keyboard.

From the back, this figure features the data-power port along with cable management solutions that accommodate both permanent and temporary setup configurations. It also shows the ease of access to the mounting hole for quick adjustments or detachment.

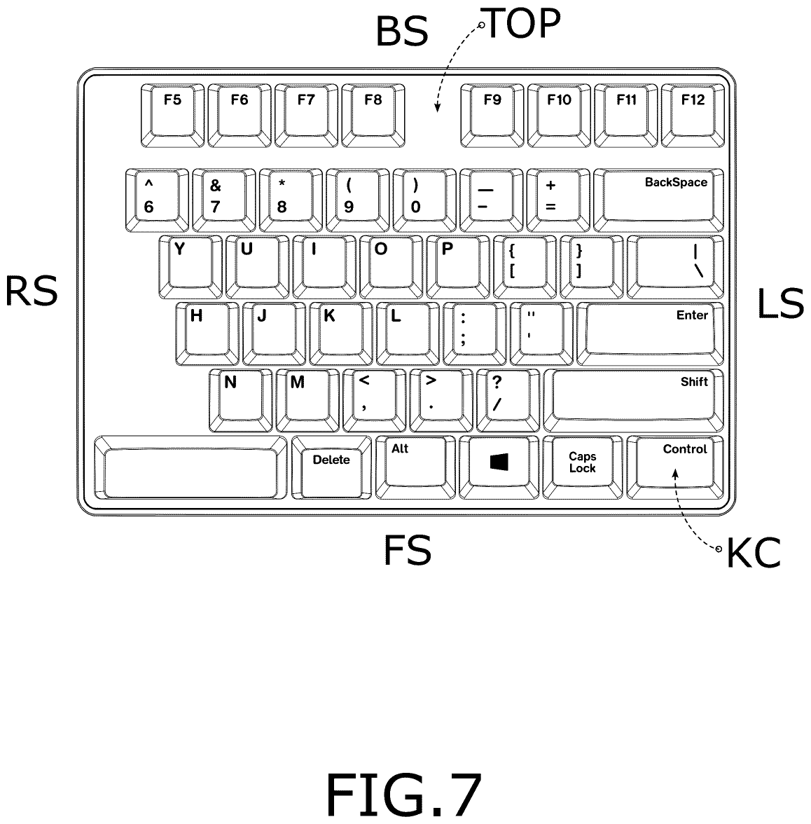

### FIG. 7: Top Perspective View

FIG. 7 is a top perspective view of a preferred embodiment of a Posture-Adaptive Keyboard showing the top-side TOP, the left-side LS, the right-side RS, the front-side FS, the back-side BS, and the keycaps KC. The keycaps may have any number of different symbols printed on them.

The top view provides a comprehensive layout of the keyboard, detailing the spacing and arrangement of keycaps. This top-down view provides a comprehensive overview of the keyboard's QWERTY layout.

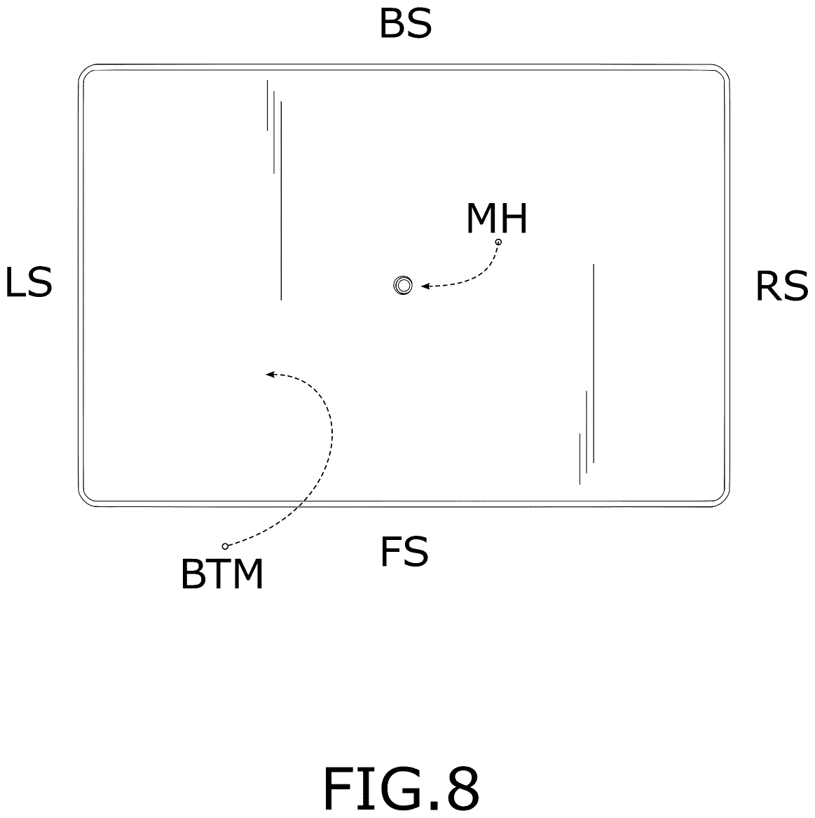

### FIG. 8: Bottom Perspective View

FIG. 8 is a bottom perspective view of a preferred embodiment of a Posture-Adaptive Keyboard showing the bottom-side BTM, the left-side LS, the right-side RS, the front-side FS, the back-side BS, and a mounting hole MH for mounting the Posture-Adaptive Keyboard to other equipment.

This view reveals the underside of the keyboard where the mounting mechanism formed within the keyboard enclosure is situated. In these figures the mounting mechanism is a standardized ¼ inch by 20 threads per inch (¼″—20 UNC) threaded hole. The bottom perspective is essential for understanding where the keyboard enclosure attaches to the articulated arm or other mounting devices, enabling it to adjust to the user's specific ergonomic requirements.

Finally, the bottom view illustrates the base of the keyboard enclosure where the mounting hole is centrally located for balanced support. In some cases the user may choose to forgo mounting the keyboard to other structures and place it flat upon a desk surface. Although traditional, this keyboard position is still an option for the user. The bottom of the keyboard enclosure in this embodiment is flat, so stick-on rubber feet or padding would improve device stability and prevent slippage on smooth surfaces if traditionally used upon a desk surface.

To form the keyboard enclosure of this preferred embodiment. A block of aluminum is cut with a CNC machine to trim away the aluminum create the enclosures shape. The CNC machine leaves a thick portion of the aluminum on the bottom of the enclosure so there is enough depth for a threaded hole to be formed within it. The depth of this hole is configured to still leave enough room for the electronics within the keyboard enclosure.

### Component Specifications and Material Choices

The enclosure of the Posture-Adaptive Keyboard is constructed to accommodate modifications in shape—from cuboid to more complex geometric forms like semi-circles or ovals—to enhance ergonomic benefits and aesthetic appeal. The choice of materials and the detailed design of the mounting system are made with consideration for durability, ease of use, and the ability to provide stable and versatile positioning solutions.

### Operational Characteristics

The mounting hole's standardized threading is critical for ensuring a wide range of compatibility with mounting structures designed to support dynamic adjustments. This feature allows users to precisely adjust the keyboard's angle, height, and tilt, thereby tailoring their setup to individual preferences and situational needs.

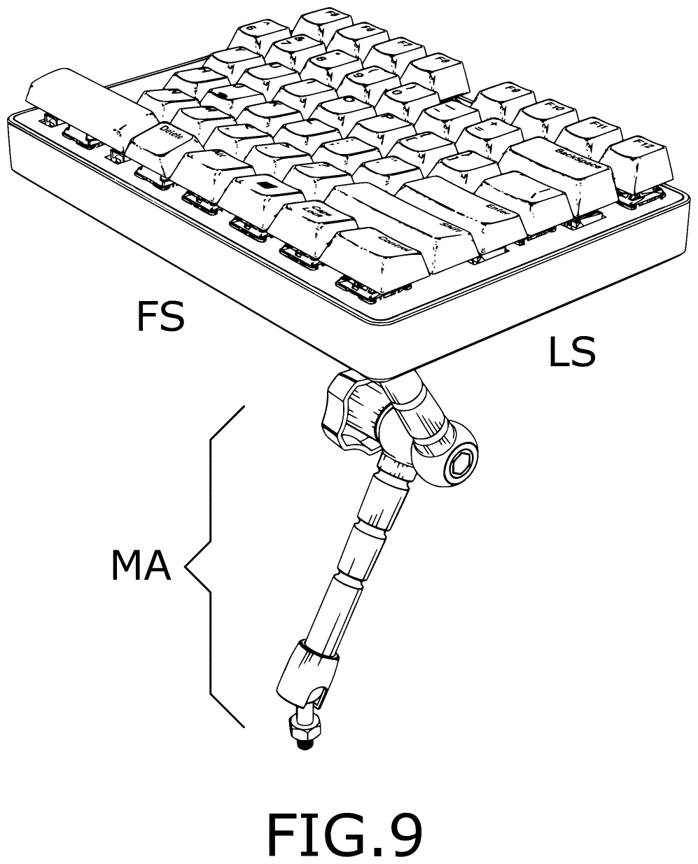

### Detailed Description Corresponding to FIG. 9 through FIG. 16

### FIG. 9: Front-Top-Left Perspective View of Second Embodiment

FIG. 9 shows a front-top-left perspective view of a second embodiment of a Posture-Adaptive Keyboard with its front-side FS and left-side LS visible. This second embodiment has a variable friction articulated-arm (“Magic Arm”) MA attached to a mounting hole which is not visible on FIG. 9.

This figure presents a front-top-left perspective of the second embodiment of the Posture-Adaptive Keyboard with the variable friction articulated arm attached. The arm is connected to the keyboard via a mounting hole configured with a ¼ inch by 20 threads per inch (¼″—20 UNC) threaded interface. This configuration allows for precise and secure attachment, facilitating easy adjustments to the keyboard's orientation and elevation to meet individual ergonomic needs.

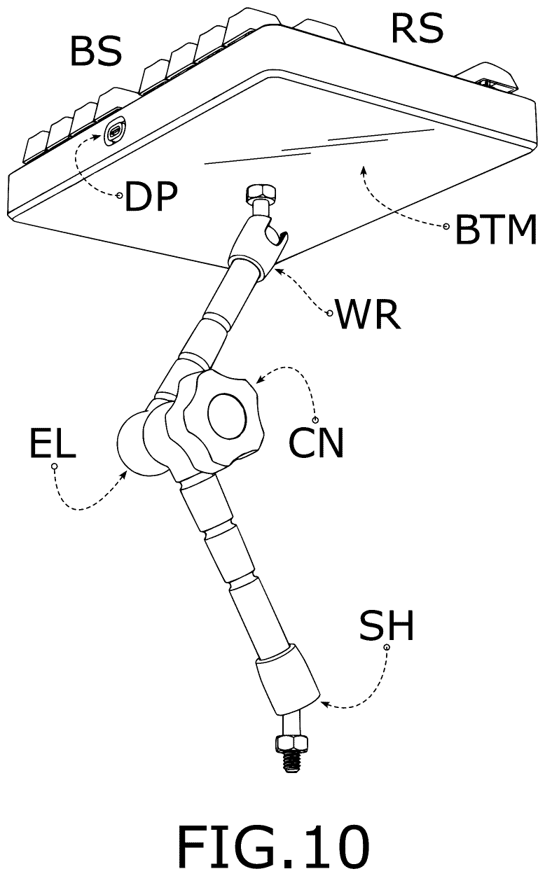

### FIG. 10: Back-Bottom-Right Perspective View

FIG. 10 is a back-bottom-right perspective view of a second embodiment of a Posture-Adaptive Keyboard showing the bottom-side BTM, right-side RS, back-side BS, data-power port DP, and sections of the variable friction articulated-arm (“Magic Arm”) including the wrist WR, elbow EL, friction control knob CN, and shoulder SH.

The back-bottom-right perspective highlights the articulated arm's components: the wrist, elbow, and shoulder joints, each with their own range of rotation and pivoting. The friction control knob located at the elbow joint is visible, which users can tighten or loosen to fix the keyboard's position in space. This figure emphasizes the keyboard's flexibility in positioning, critical for achieving optimal ergonomic configurations.

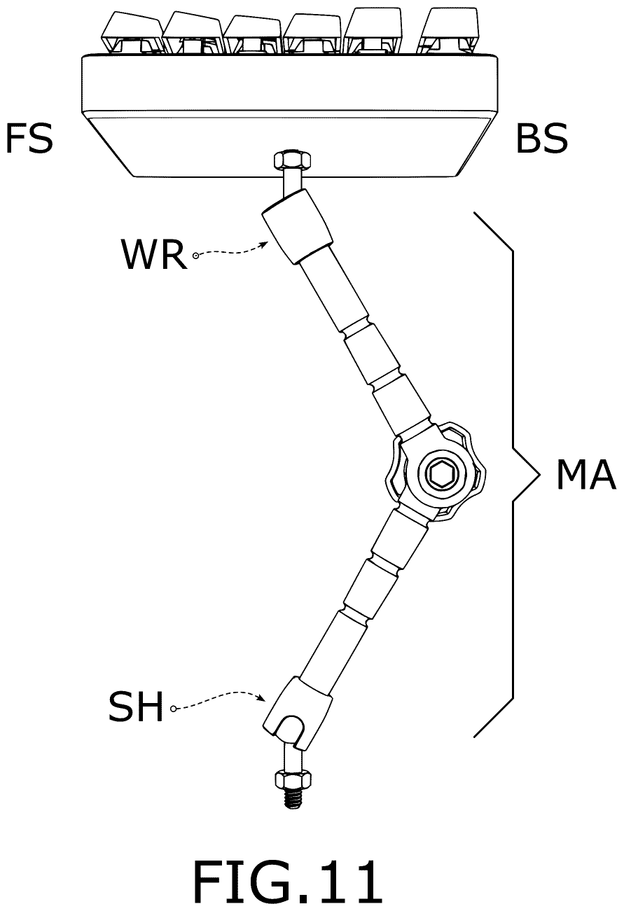

### FIG. 11: Left Perspective View

FIG. 11 is a left perspective view of a second embodiment of a Posture-Adaptive Keyboard, showing a variable friction articulated-arm (“Magic Arm”) MA attached to a mounting hole on the conforming keyboard which is not visible in FIG. 11 because one end of the variable friction articulated-arm (“Magic Arm”) is inserted therein. Visible sections of the variable friction articulated-arm (“Magic Arm”) MA include the wrist WR and shoulder SH.

This view illustrates the left perspective of the keyboard attached to the articulated arm. It showcases the integration point and how the arm extends from the bottom of the keyboard enclosure, allowing the keyboard to hover above, or off to the side of a work surface if needed. This setup is ideal for users who require adjustable height and angle to alleviate strain on the wrists and neck during prolonged use.

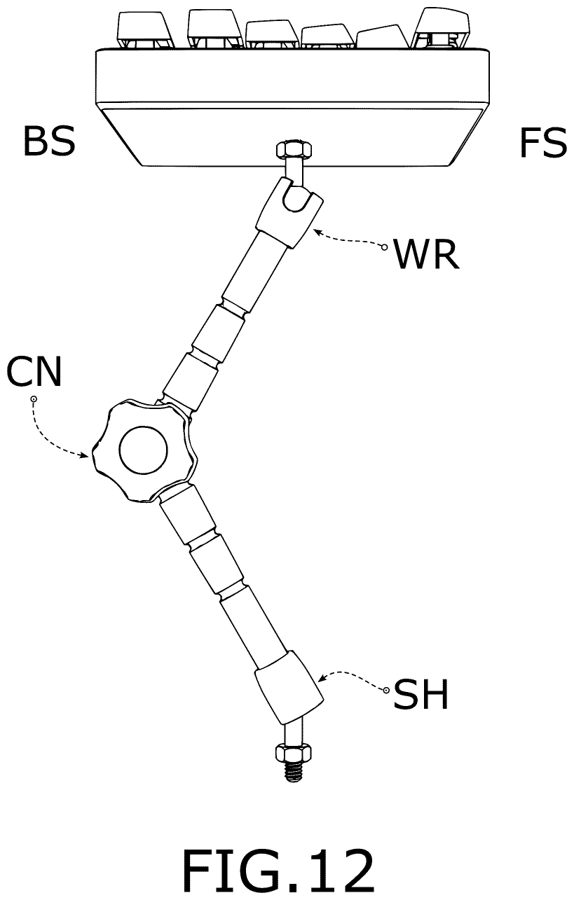

### FIG. 12: Right Perspective View

FIG. 12 is a right perspective view of a second embodiment of a Posture-Adaptive Keyboard, showing a variable friction articulated-arm (“Magic Arm”) attached to a mounting hole which is not visible in FIG. 12. because one end of the arm is inserted therein. Visible sections of the variable friction articulated-arm include the wrist WR, friction control knob CN, and shoulder SH.

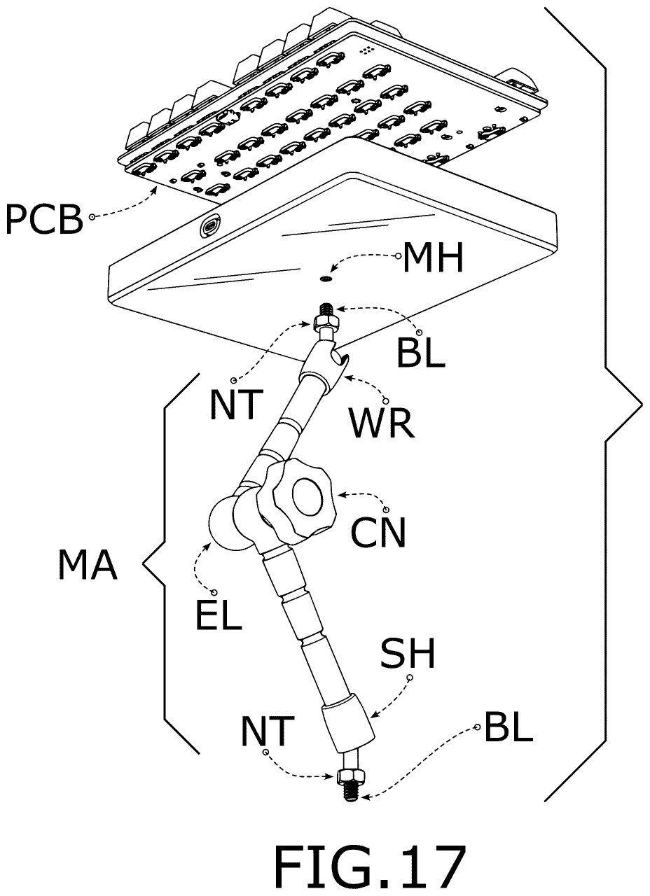

In the same pose as the left perspective, this view clearly shows the friction control knob. The control knob is key to controlling the articulation of the arm and its positioning capabilities. The friction control knob's accessibility for the user is highlighted, showing how adjustments can be made quickly and easily to cater to changing ergonomic requirements throughout the workweek. Simply turning to loosen the knob, repositioning the keyboard by adjusting the positions and angles of the wrist, elbow, and shoulder of the arm, then tightening the knob fixes the keyboard into any new position. A variable friction articulated arm is described further in the detailed description of FIG. 17. The articulated arm is a product that has been available on the market for several years and therefore the intricacies of its internal design will not be unnecessarily described.

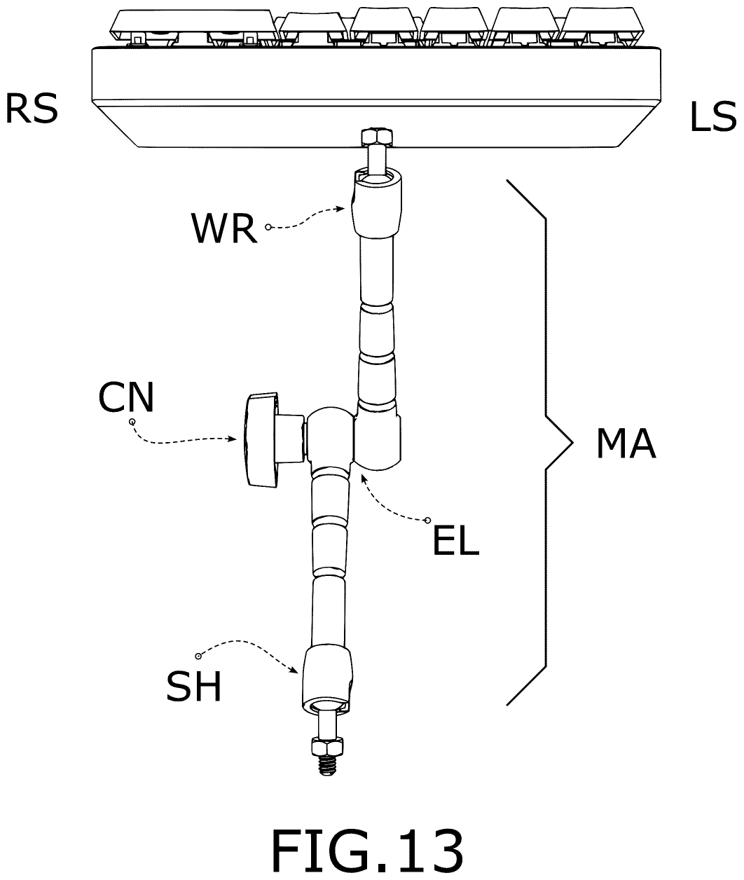

### FIG. 13: Front Perspective View

FIG. 13 is a front perspective view of a second embodiment of a Posture-Adaptive Keyboard, showing a variable friction articulated-arm (“Magic Arm”) MA attached to a mounting hole not visible in FIG. 13 because one end of the variable friction articulated-arm (“Magic Arm”) is inserted therein. The visible sections of the variable friction articulated-arm (“Magic Arm”) MA include the wrist WR, elbow EL, friction control knob CN, and shoulder SH.

From the front, this view more closely resembles the operational stance of the keyboard from the user point of view when mounted on the articulated arm. The elevation and tilt adjustments visible here are fixed in the same pose and position to remain consistent with the other figures presented in this disclosure. The description of the primary function of the arm in FIG. 12 is meant to illustrate the extensive range of ergonomic customization available, which can significantly enhance user comfort and reduce injury risks.

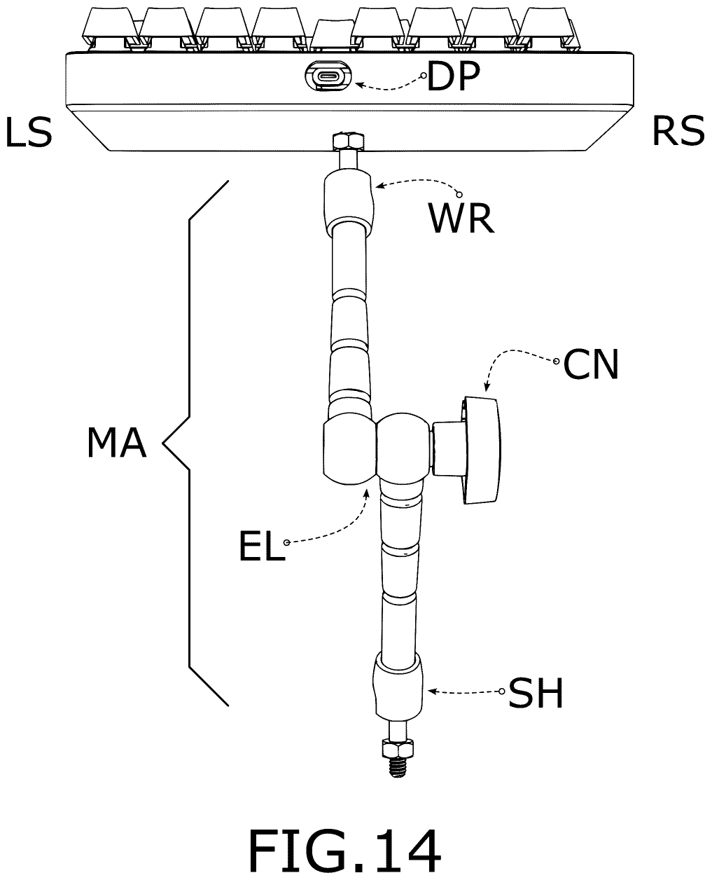

### FIG. 14: Back Perspective View

FIG. 14 is a back perspective view of a second embodiment of a Posture-Adaptive Keyboard, showing a data-power port DP, and a variable friction articulated-arm (“Magic Arm”) MA, its shoulder SH, elbow EL, friction control knob CN, and wrist WR attached to a mounting hole which is not visible in FIG. 14 because one end of the variable friction articulated-arm (“Magic Arm”) MA is inserted therein.

The back perspective offers a closer look at where cables (if wired) would be routed from and the placement of the data-power port in relation to the keyboard assembly of this embodiment. This configuration ensures that cable management is streamlined and does not interfere with the arm's adjustability or the keyboard's stability.

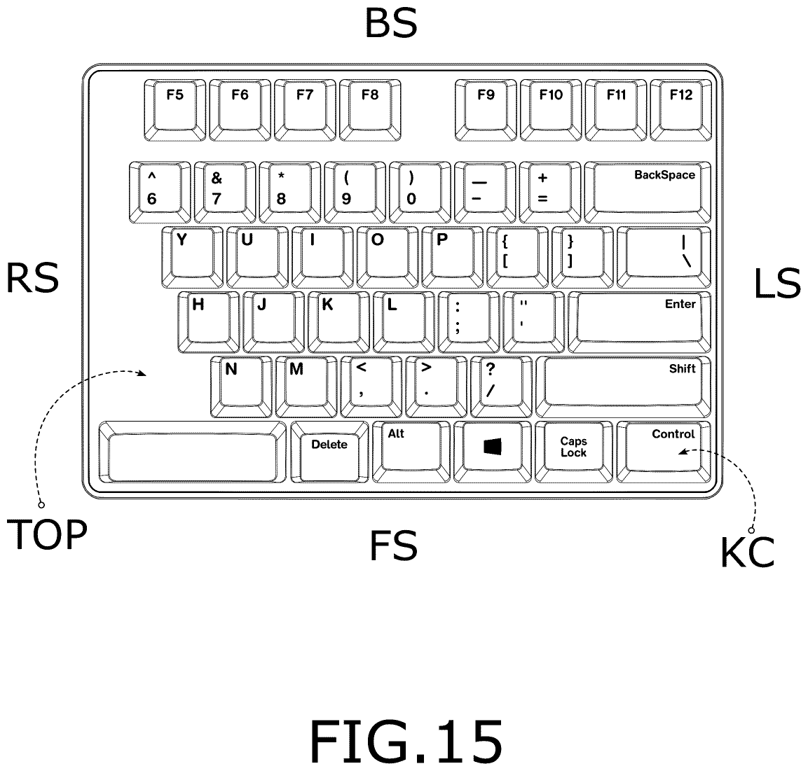

### FIG. 15: Top Perspective View

FIG. 15 is a top perspective view of a second embodiment of a Posture-Adaptive Keyboard, showing the top-side TOP, front-side FS, back-side BS, left-side LS, right-side RS, and keycaps KC with any number of symbols printed on them.

Providing a top-down view of the keyboard, this figure displays the layout of the keycaps and obstructs the view of the arm attached to the bottom.

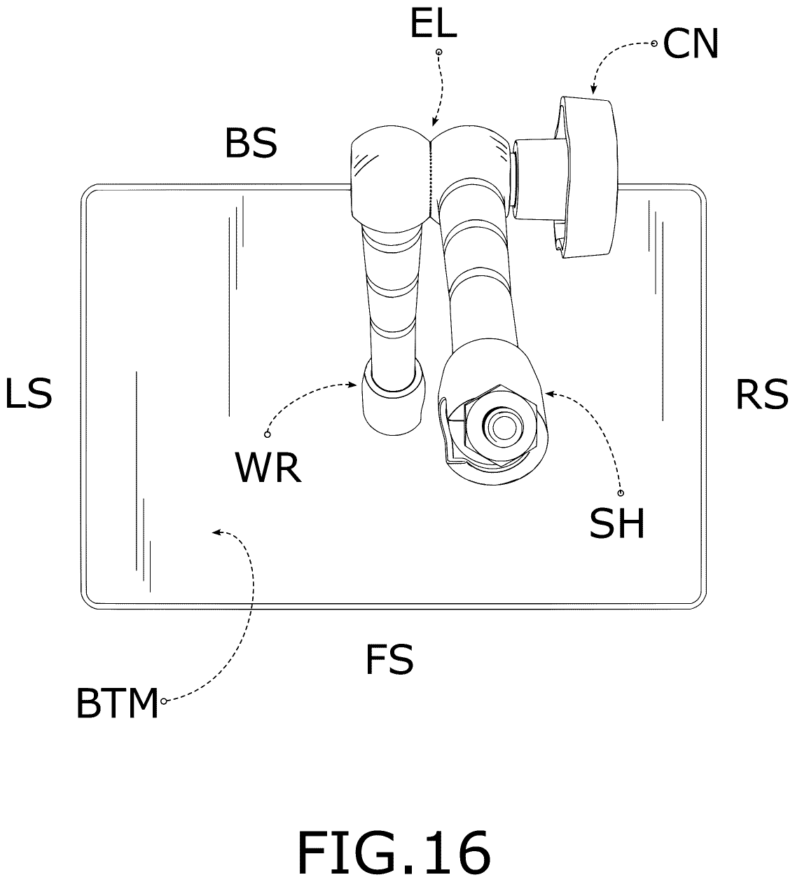

### FIG. 16: Bottom Perspective View

FIG. 16 is a bottom perspective view of a second embodiment of a Posture-Adaptive Keyboard, showing the wrist WR, elbow EL, friction control knob CN, and shoulder SH of a variable friction articulated-arm (“Magic Arm”) attached to the mounting hole which is not visible in FIG. 16 because one end of the variable friction articulated-arm (“Magic Arm”) is inserted therein. The bottom-side BTM is visible.

This view exposes the underside of the keyboard assembly where the articulated arm attaches to the bottom of the enclosure.

### Detailed Description Corresponding to FIG. 17

### FIG. 17: Exploded View of the Posture-Adaptive Keyboard Assembly of FIG. 10

FIG. 17 is an exploded view of FIG. 10 showing a variable friction articulated-arm (“Magic Arm”) MA detached from a mounting hole MH. Shown are the different sections of the arm: Bolt BL, nut NT, wrist WR, elbow EL, friction control knob CN, shoulder SH, distal nut NT, and distal bolt BL. The nut and bolt at either end of the arm is identical in shape and form. The position in relation to which end of the arm is attached to the keyboard enclosure is the only thing that differentiates the nut and bolt. A printed circuit board PCB is in view beneath the keyswitches.

This figure description provides an exploded view detailing the assembly of this Posture-Adaptive Keyboard embodiment and the connection between the keyboard and the variable friction articulated arm where it attaches to the keyboard enclosure. This figure description details how the friction control knob functions to lock and unlock the arm's joints, allowing for smooth yet secure adjustments of the keyboard's position. This explanation will cover the mechanical workings of the friction control system, demonstrating how users can easily modify their keyboard setup to achieve their desired ergonomic posture. The following components are essential for understanding the setup and functionality:

Variable Friction Articulated Arm Components: The articulated arm comprises several pivotal joints including the wrist WR, elbow EL, and shoulder SH. These joints are connected in a manner that allows comprehensive movement—rotational and angular adjustments—facilitated by the friction control knob CN. This knob is designed to adjust the tension within the joints, thereby allowing the arm to maintain a desired position once set by the user. Articulated arms are available in different lengths, and any length of arm may be used for this assembly. To include a sense of scale, the arm depicted in this figure is 11 inches long when fully extended. A shorter arm or longer arm may be used and each length has its own advantages and disadvantages when integrated into the Posture-Adaptive Keyboard assembly.

Mounting Hole (MH): This is one form of an integrated mounting mechanism located on the bottom side of this embodiment of the keyboard enclosure, its threaded hole is standardized to ¼ inch by 20 threads per inch (¼″—20 UNC). It serves as the proximal attachment point for the articulated arm, ensuring a secure and stable connection that supports the weight of the keyboard while allowing for full rotational and angular adjustment.

Friction Control Knob (CN): This knob is critical for the user-adjustable positioning feature of the keyboard. This knob plays a crucial role in adjusting the tension within the joints of the articulated arm. By tightening or loosening the knob, users can modify the stiffness of the arm's joints to either lock the keyboard in place or allow for movement to adjust its position. In other words, by tightening or loosening this knob, the user can either secure the keyboard in a desired position or allow for its repositioning. The design of the knob ensures ease of use, enabling quick adjustments that can be done without the need for tools. The orientation of the keyboard may also be directly manipulated by grabbing onto the keyboard enclosure and pushing, pulling or twisting the keyboard into a desired position without tightening or loosening the friction control knob: Direct manipulation. This mechanism is crucial for dynamic ergonomic setups, enabling users to adjust the keyboard's posture according to their immediate needs.

Printed Circuit Board (PCB): Shown beneath the keyswitches, the PCB layout is the electronic component for the keyboard's functionality, routing signals and power between the keyswitches and the connected computing device. Special care has been taken to optimize the space within the keyboard enclosure to allow just enough of a gap between the PCB and the housing of the enclosure's integrated mounting mechanism to ensure there is no interference between the PCB and the enclosure.

Connection Mechanism Details: This exploded view details how the wrist WR of the articulated arm connects to the mounting hole MH in the keyboard enclosure. This connection is facilitated by a coupling system that may optionally include a washer, not shown in this figure, when included helps distribute the load evenly and prevents wear. The standardized bolt BL, inserted through an optional washer not shown, securely fastens the arm to the mounting hole MH of the keyboard enclosure. The nut NT is secured to the threads of the bolt BL with a glue popularly known as “Thread locker” and enables a wrench tool to grab onto it in the event the bolt BL is screwed on too tightly and is difficult to remove by hand. The optional washer, that would be situated on the bolt BL and between the nut NT and mounting hole MH is not shown in this figure to avoid obscuring the view of the core components of the attachment mechanism for this embodiment. The assembly depicted is functional without a washer installed but if an optional washer, especially a spring lock washer, is included in the arm's attachment to the mounting hole MH, these components work together to distribute load evenly, improve the attachment, and maintain stability under various typing conditions.

Adjustment Mechanism: The adjustment mechanism of the articulated arm is designed to provide precise control over the keyboard's orientation and elevation. This mechanism not only enhances the ergonomic setup but also supports dynamic changes in user posture, crucial for adapting to various work environments and user preferences.

This detailed depiction is instrumental in demonstrating how the articulated arm enhances the keyboard's ergonomic adaptability. The design allows for easy adjustments while ensuring that the keyboard remains stable and securely positioned, thus aligning with the invention's claims regarding ergonomic benefits and user-centric design.

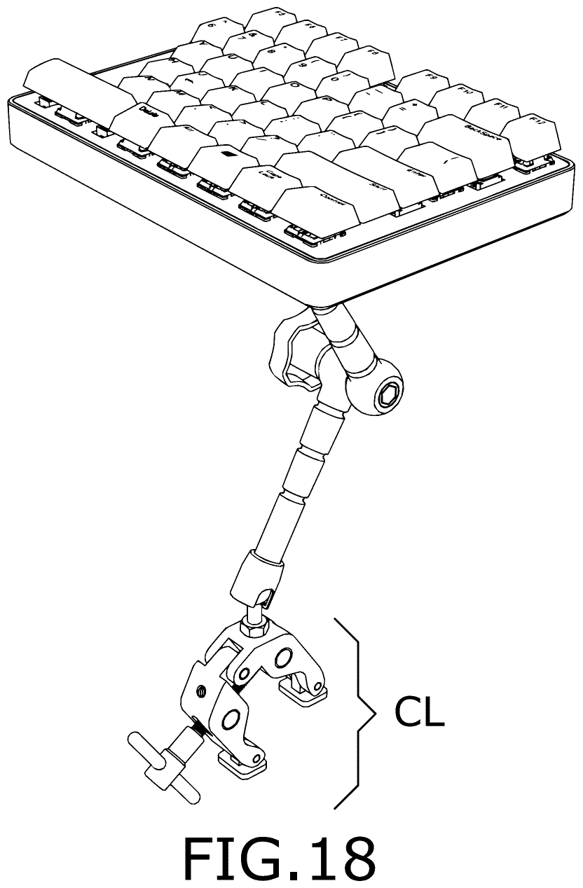

### Detailed Description Corresponding to FIG. 18 through FIG. 25

### FIG. 18: Third Embodiment Featuring Clamp Attachment

FIG. 18 illustrates the third embodiment of the Posture-Adaptive Keyboard, which includes the integration of a clamp CL at the distal end of the variable friction articulated arm. This embodiment highlights the keyboard's adaptability to various user environments by showcasing its ability to be securely mounted to different structural elements, such as desk edges or chair armrests. The following components and features are crucial for understanding this embodiment's functionality and ergonomic advantages:

### Key Features of FIG. 18:

Variable Friction Articulated Arm: Extending from the keyboard's integrated mounting mechanism, the articulated arm enables comprehensive adjustability in positioning the keyboard. The arm's design allows for movements across three axes—x (horizontal), y (vertical), and z (angular)—which is essential for achieving optimal ergonomic alignment with the user's posture.

Clamp (CL): The clamp serves as a versatile attachment point that can securely grip various surfaces and thicknesses. Its robust construction ensures that the keyboard remains stable and fixed in the desired position, despite the applied typing forces or adjustments. The clamp's design accommodates a wide range of attachment surfaces, from flat desk edges to rounded chair armrests and pipe shaped structures, providing a reliable solution for dynamic workspace setups.

Integration with Articulated Arm: The clamp is affixed to the distal end of the articulated arm, which enables the keyboard to be attached to a variety of surfaces.

Ergonomic Benefits: By allowing the keyboard to be mounted on various surfaces, this embodiment significantly enhances the ergonomic flexibility of the setup. Users can adjust the keyboard's position to avoid strain on the wrists, neck, and shoulders, which is particularly beneficial for long periods of typing. This setup not only adapts to the user's natural posture but also contributes to preventing repetitive stress injuries (RSIs), aligning with the invention's ergonomic objectives. This functionality is key for users who may need to frequently reposition their keyboard throughout the week, as it supports dynamic ergonomic adjustments without requiring extensive effort or additional tools.

Application and Use Case: The practical application of this embodiment is particularly beneficial in environments where desk space is limited or where the user may benefit from having the keyboard positioned off to the side of the traditional work surface, such as in specialized ergonomic setups or in gaming environments where space and positioning flexibility are crucial. Additionally, users have reported that the newly freed-up space on the desktop, previously occupied by a traditional keyboard, is now available for placing paperwork, office supplies, or other commonly used items, adding a layer of convenience to their workspace.

This detailed description of FIG. 18 ties directly into the overall utility and innovative aspects of the Posture-Adaptive Keyboard, emphasizing its ergonomic adaptability and user-centric design. The clamp's integration with the articulated arm showcases a practical application of the invention's versatility, enhancing user comfort and productivity across various computing environments.

### Conclusion for FIG. 18:

FIG. 18 not only illustrates the mechanical integration of the clamp and articulated arm but also highlights the ergonomic advantages this setup provides. By allowing the keyboard to be securely mounted to various surfaces, it enhances the adaptability of the Posture-Adaptive Keyboard, catering to a wide range of user preferences and working conditions. This embodiment exemplifies the invention's capacity to deliver a customizable and ergonomically optimized typing experience, thereby addressing the critical need for ergonomic computing peripherals that actively contribute to user health and productivity.

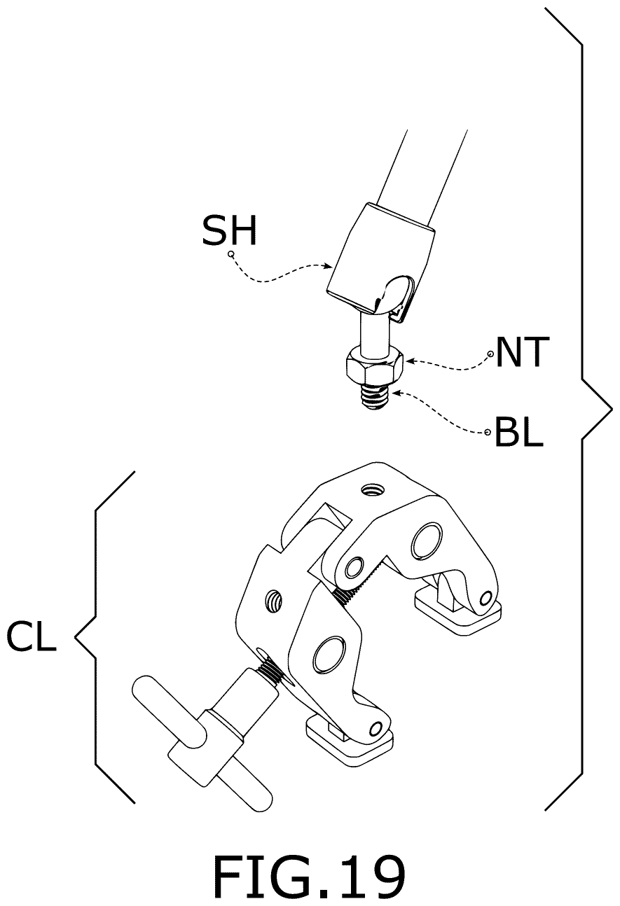

### FIG. 19: Exploded Close-Up View of Clamp Attachment

FIG. 19 is an exploded close-up view of the clamp CL and shoulder SH of FIG. 18 where the magic arm shoulder SH is attached to the clamp CL. In order to attach the magic arm to the clamp CL, first, the nut NT is attached to the bolt BL with optional Threadlocker glue, then, the bolt BL may be attached to the clamp CL. After the bolt BL is attached to the clamp CL, the nut NT shall be flush with the clamp CL surface. In most use cases the additional Threadlocker glue on the bolt BL and the clamp CL threads is preferred because this stabilizes the attachment at the shoulder SH. Without Threadlocker glue on the clamp CL clamp threads the arm could inadvertently rotate upon the clamp CL thereby causing the user selected position to stray.

This figure provides an exploded close-up view of the clamp mechanism used in the third embodiment of the Posture-Adaptive Keyboard. The key features below further describe the mechanical details showing how the clamp CL connects to the distal end of the variable friction articulated arm, a key component in allowing the keyboard to be affixed to various structural elements securely.

### Key Features of FIG. 19:

Clamp Mechanism (CL): The clamp is designed to securely grip various types of surfaces and edges, from flat desk tops to rounded chair armrests. The clamp chosen for this assembly has a handle for adjusting to the thickness of mounting surfaces, and the distance of the clamp's grasp. The exploded view illustrates the general components and overall structure that form the clamp. It does not show the thin padding that protects the surface from damage while ensuring a firm grip. This is crucial in preventing the keyboard from shifting or slipping under the force of typing or when adjustments are made.

Connection to Articulated Arm: This figure details how the clamp is attached to the articulated arm. The components shown include the bolt BL and nut NT, which are crucial for securing the clamp to the shoulder SH portion of the arm. These fasteners are designed to ensure a stable and robust connection, which is vital for maintaining the desired position of the keyboard once adjustments are made.

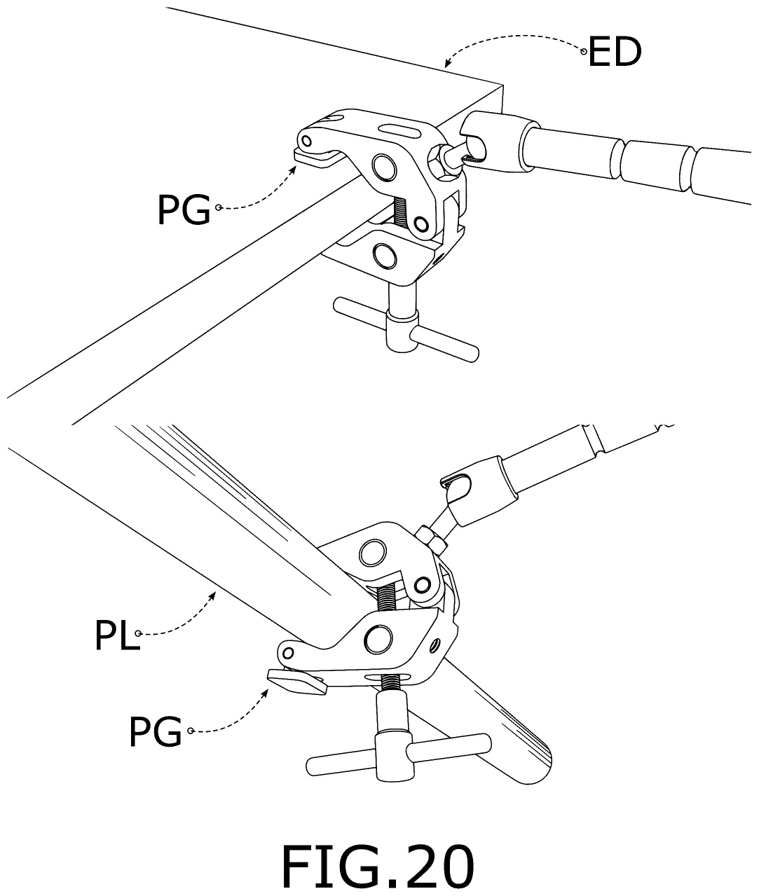

### FIG. 20: Clamp in Use on Various Structural Elements

This figure showcases the practical application of the clamp mechanism from the third embodiment of the Posture-Adaptive Keyboard, illustrating how it securely attaches to both a flat desk edge ED and a rounded pole PL structure. FIG. 20 provides two close-up views that emphasize the clamp's versatility and robustness in different mounting scenarios, essential for users who may need to adjust their keyboard's position based on their workspace configuration.

### Key Features of FIG. 20:

Versatile Mounting Capability: The first close-up view in this figure displays the clamp attached to the edge of a desk ED. This setup demonstrates the clamp's ability to grip flat surfaces tightly, providing a stable and secure base for the keyboard. The second close-up view shows the clamp mounted on a rounded pole PL, highlighting its flexible design that can conform to and firmly grip cylindrical structures as well.

Clamp Design and Functionality: Each view illustrates the mechanics of the clamp, including how the pivoting grips PG accommodate different surface types and may pivot out of the way for contoured surfaces. The clamp's design ensures that it can be easily and securely fastened, offering strong support and stability for the keyboard, thereby enhancing the user's ergonomic setup.

### Ergonomic and Practical Benefits:

Adaptability to Various Environments: By demonstrating the clamp's ability to attach to both flat and rounded structures, this figure underscores the keyboard's high degree of adaptability. This feature is particularly beneficial in diverse work settings, from traditional offices to dynamic home environments or specialized setups like studios or workshops.

Enhanced User Comfort: The secure mounting enabled by the clamp allows users to position their keyboard at the most comfortable height and angle. This adaptability helps prevent strain on the wrists, neck, and back, contributing to a healthier work posture and increased productivity.

Ease of Installation and Adjustment: The detailed views also highlight the ease with which the clamp can be adjusted and secured, emphasizing the user-friendly nature of the Posture-Adaptive Keyboard's design. This ease of use encourages users to make ergonomic adjustments as needed, promoting better health outcomes.

### Conclusion for FIG. 20:

FIG. 20 effectively illustrates the clamp's functionality as a versatile and robust mounting solution for the Posture-Adaptive Keyboard, capable of securely attaching to a variety of structural elements. The lines depicting the edges of a desk ED and the pole structure PL are environmental structures and non-claimed elements of the keyboard. This clarifies that the claim focuses on the clamp mechanism itself, not on the objects to which it is attached.

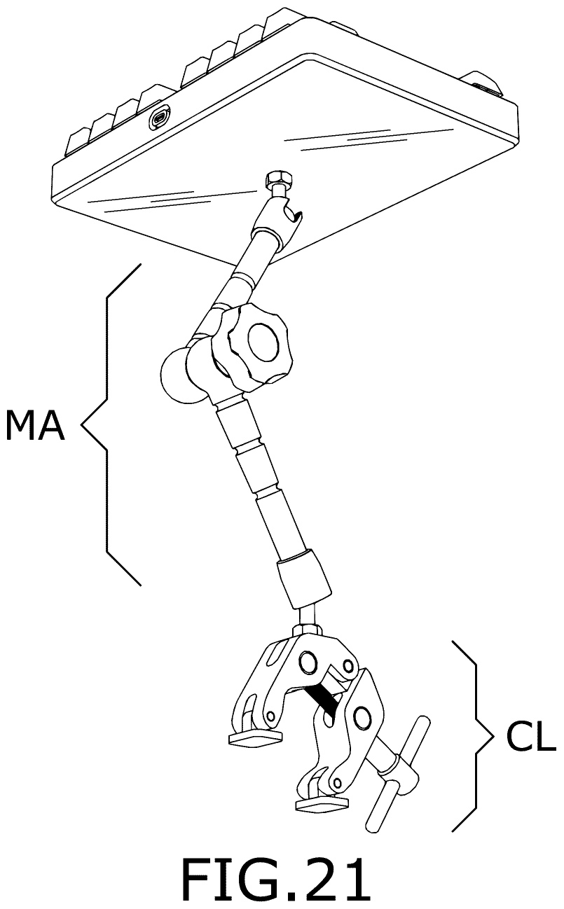

FIG. 21 shows a third embodiment of a Posture-Adaptive Keyboard showing FIG. 10 attached to a clamp CL.

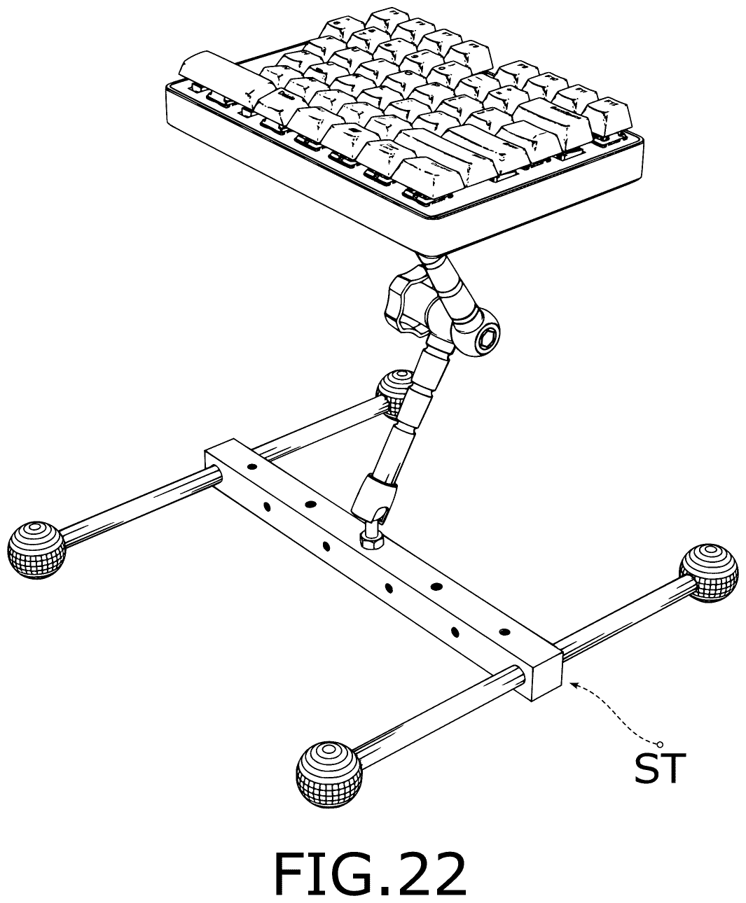

FIG. 22 shows a fourth embodiment of a Posture-Adaptive Keyboard showing FIG. 9 attached to a stand ST.

### Fourth Embodiment Featuring Stand Attachment

FIG. 22 illustrates a variant of the Posture-Adaptive Keyboard utilizing a stand ST for support, showcasing an alternative mounting option that enhances the device's versatility and ergonomic adaptability.

### Key Aspects of FIG. 22:

Stand Integration: This figure presents the keyboard attached to a stand that is designed to offer stable support on flat surfaces such as floors or large furniture tops. The stand provides a solid base that allows the keyboard to be elevated to various heights, catering to the ergonomic needs of users whether they are standing or sitting.

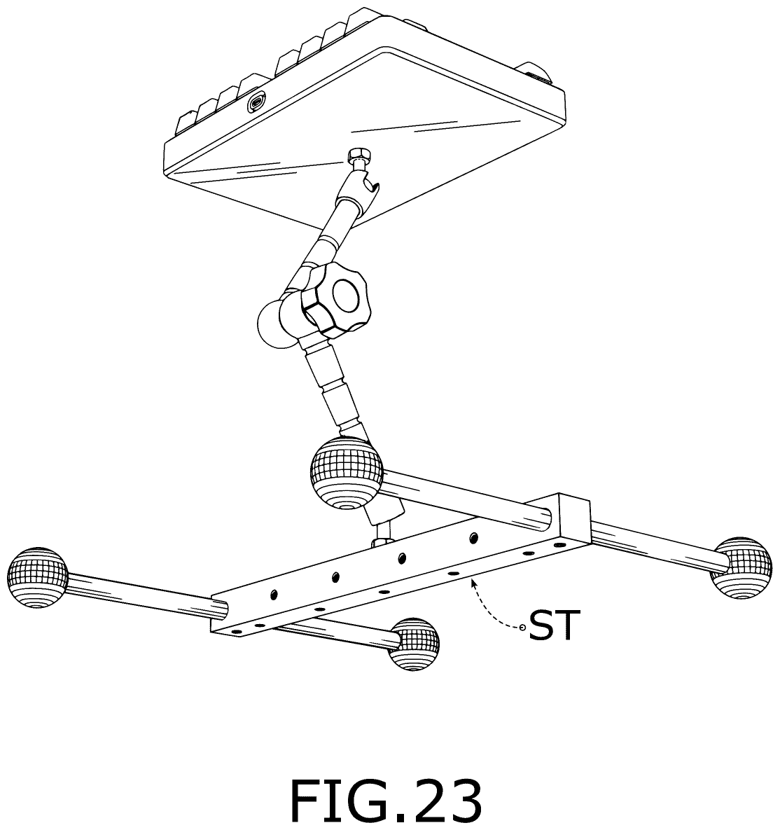

FIG. 23 shows a fourth embodiment of a Posture-Adaptive Keyboard showing FIG. 10 attached to a stand ST.

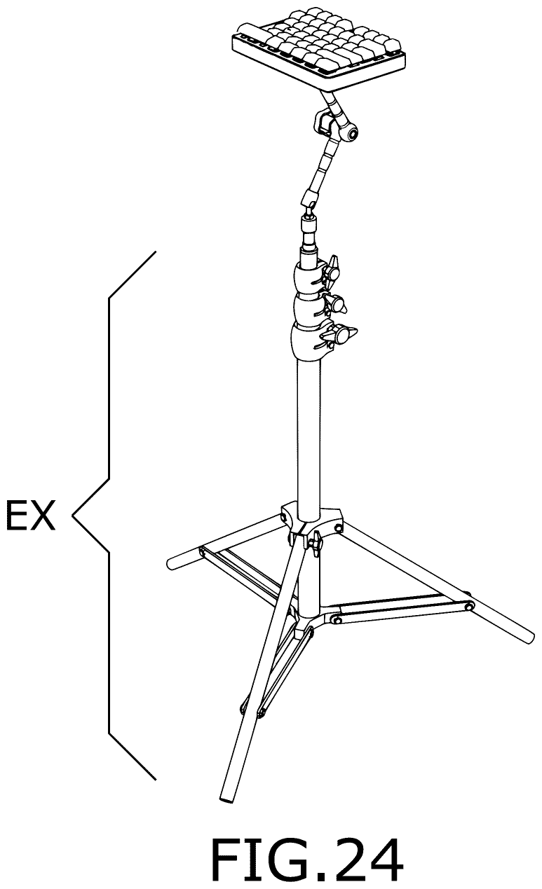

### FIG. 24: Fifth Embodiment Featuring Extendable Stand Attachment

FIG. 24 shows a fifth embodiment of a Posture-Adaptive Keyboard showing FIG. 9 attached to an extendable stand EX. The extendable stand EX is typically used in the photography equipment industry for holding light fixtures and other photography equipment. It is typically constructed of two or more telescoping poles that are user-adjustable to a desired length. The desired length is fixed by friction control knobs at the top end of each telescoping pole.

FIG. 24 portrays another versatile setup for the Posture-Adaptive Keyboard, demonstrating its attachment to an extendable stand EX, which is commonly utilized within the photography and lighting industries for its height-adjustable capabilities.

### Key Features of FIG. 24:

Extendable Stand (EX): The extendable stand featured in this figure allows for significant vertical adjustment, making it an ideal choice for both seated and standing workstations. This type of stand is typically made from lightweight yet durable materials like aluminum, which can telescope to various heights and securely lock in place.

Integration with Keyboard: The stand interfaces with the keyboard via a robust mounting mechanism, shown in FIG. 24 integrating the articulated arm as a part of its attachment assembly. A compatible adapter at the base of the keyboard enclosure is an alternative for attachment to the extendable stand EX. This setup supports the keyboard's weight and facilitates quick adjustments in height and orientation, highlighting the system's ergonomic flexibility.

Height Adjustment Mechanism: The extendable stand is equipped with friction control knobs that enable precise height modification. These knobs ensure that once the desired height is set, the stand remains stable, even during intense typing sessions.

### Utility and Ergonomic Benefits Highlighted in FIG. 24:

This configuration serves multiple ergonomic and practical purposes, illustrating the keyboard's extensive adaptability to different user needs and work environments.

Versatile Work Environments: Ideal for environments such as shared office spaces, studios, or at-home setups where the user may transition between sitting and standing. The extendable stand provides a stable base with easy-to-adjust features that cater to varying ergonomic requirements.

Promoting Ergonomic Health: The ability to adjust the keyboard's height to a precise level allows users to maintain better posture, reducing the risk of neck and back strain, and enhancing overall comfort during use.

Space Efficiency: Utilizing an extendable stand minimizes the footprint of the setup when not in use, as it can be retracted and stored away. This feature is particularly beneficial in multi-functional spaces that are used for a variety of activities beyond computing.

### Conclusion for FIG. 24:

FIG. 24 effectively demonstrates the functionality of the extendable stand as a dynamic and robust support for the Posture-Adaptive Keyboard. It underscores the invention's commitment to providing ergonomic, flexible, and user-friendly computing solutions. This embodiment particularly showcases how the keyboard can be seamlessly integrated into various settings, enhancing user comfort and adaptability.

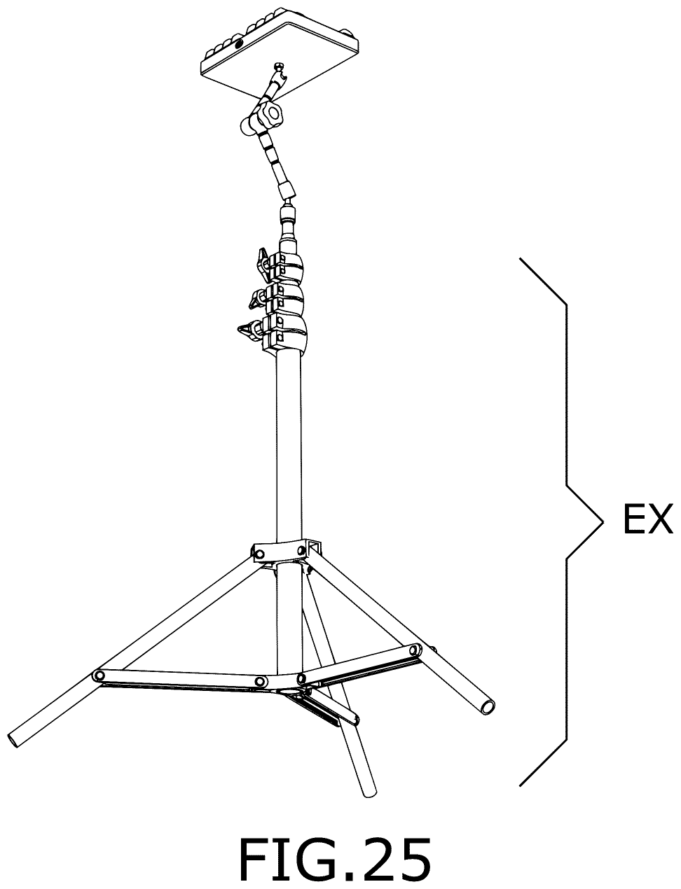

FIG. 25 shows a fifth embodiment of a Posture-Adaptive Keyboard showing FIG. 10 attached to an extendable stand EX.

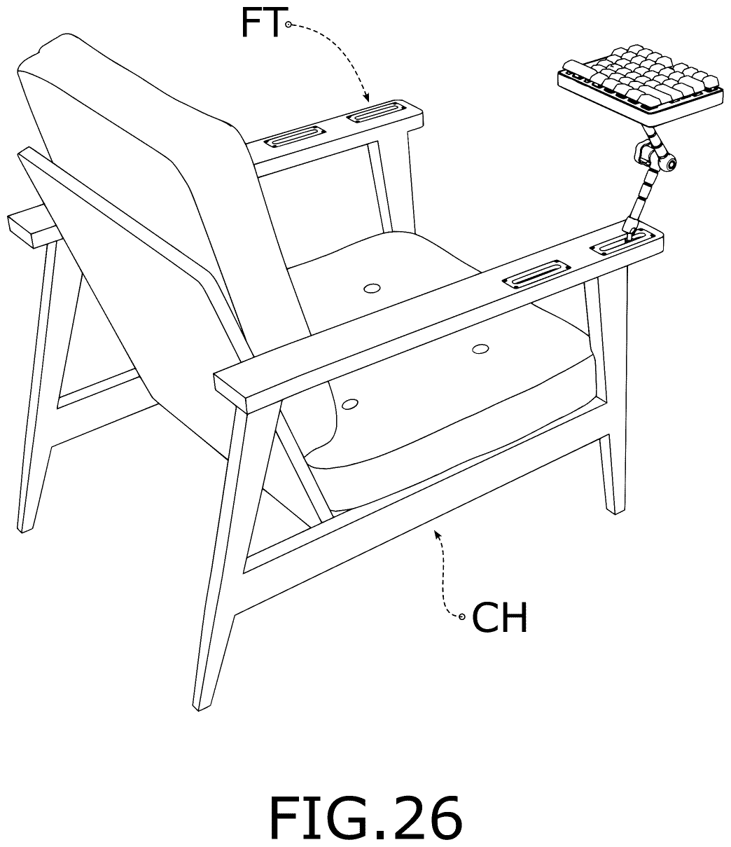

### Detailed Description Corresponding to FIG. 26 through FIG. 29

### FIG. 26: Sixth Embodiment Featuring Attachment to a Chair Fixture-Track

FIG. 26 shows a sixth embodiment of a Posture-Adaptive Keyboard showing FIG. 9 attached to the fixture-track FT of a chair CH.

FIG. 26 demonstrates the Posture-Adaptive Keyboard attached to a fixture-track FT specifically integrated into a chair CH. This embodiment highlights the adaptability of the keyboard to user-specific ergonomic settings facilitated by chair-mounted setups.

### Key Features of FIG. 26:

Fixture-Track Integration: The fixture-track FT is a specialized track built into the arm or side of a chair, designed to hold attachments such as armrests or, in this case, a Posture-Adaptive Keyboard. This track allows for horizontal and some degree of vertical movement, enabling the keyboard to slide closer or further from the user as needed.

Chair Compatibility: This embodiment is designed to complement office chairs or gaming chairs that come with customizable attachment points. This compatibility significantly enhances the user's ability to maintain an ergonomic posture while providing the convenience of keeping the keyboard within easy reach.

### Utility and Ergonomic Benefits Highlighted in FIG. 26:

This configuration addresses specific ergonomic needs by allowing the keyboard to be positioned in direct relation to the user's seating position, thus supporting more natural body alignment and reducing the need for excessive reach or strain.

Customizable Ergonomic Positioning: By attaching the keyboard directly to the chair, the user can adjust its position according to their seating preference, which is crucial for maintaining ergonomic integrity throughout extended periods of computer use.

Enhanced Comfort and Accessibility: This setup facilitates easy adjustments to the keyboard's location relative to the user's seat, ensuring that it can be optimally positioned for both comfort and functionality during use.

### Conclusion for FIG. 26:

FIG. 26 effectively illustrates the innovative integration of the Posture-Adaptive Keyboard with a chair fixture-track, underscoring the keyboard's ergonomic versatility and its capacity to adapt to highly personalized user environments. This embodiment is particularly beneficial in scenarios where desk space is limited or where the user requires constant adjustments to their keyboard's position relative to their seat. The chair-mounted fixture-track not only maximizes space efficiency but also enhances the overall ergonomic benefit of the computing setup.

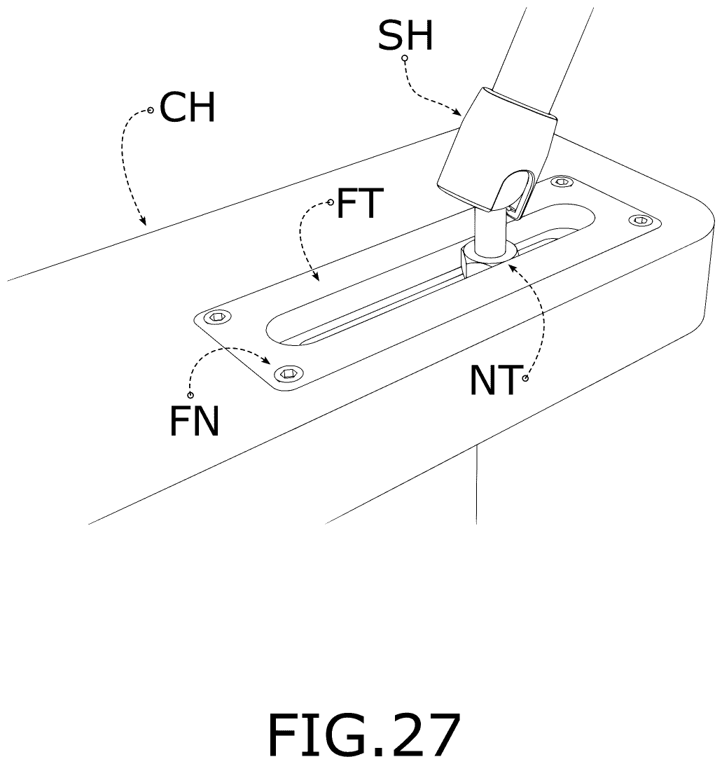

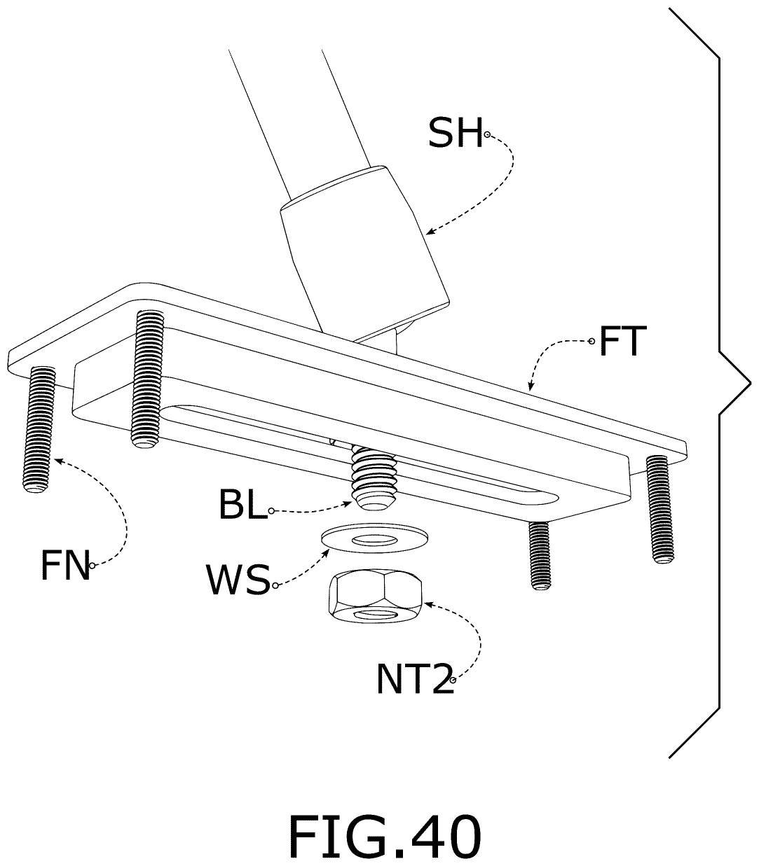

FIG. 27 is a close-up view of FIG. 26 showing where the articulated arm shoulder SH is attached to the fixture-track FT of a chair CH; and the top of the fasteners FN are shown, which attach the fixture-track FT to the chair CH. The fixture-track FT prevents the nut NT from turning after the Posture-Adaptive Keyboard arm is attached. An additional nut (shown in FIG. 40), or other form of fastener is used on the end of the bolt to attach the shoulder SH to the fixture-track FT of a chair CH.

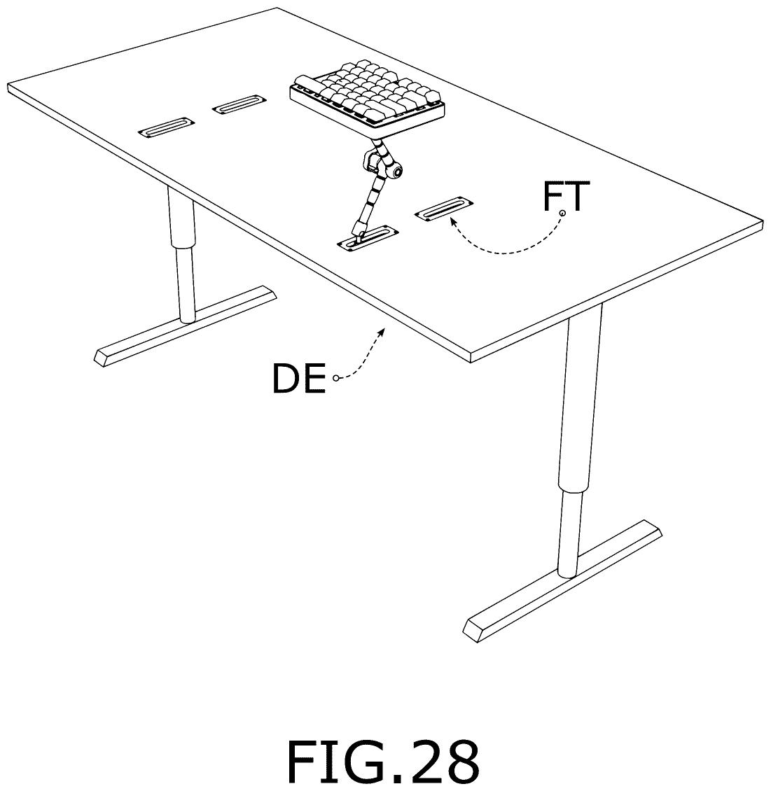

### FIG. 28: Seventh Embodiment Featuring Attachment to a Desk Fixture-Track

FIG. 28 shows a seventh embodiment of a Posture-Adaptive Keyboard showing FIG. 9 attached to the fixture-track FT of a desk DE.

FIG. 28 showcases the Posture-Adaptive Keyboard affixed to a fixture-track FT integrated into a desk DE. This setup leverages the structural elements of workplace furniture to enhance the keyboard's ergonomic positioning and accessibility.

### Key Features of FIG. 28:

Desk Fixture-Track Integration: The fixture-track embedded within the desk provides a dedicated and stable mounting pathway for the keyboard.

Desk Compatibility: This embodiment is specifically advantageous for office setups where desk space is premium or ergonomically configured desks are employed. It facilitates a clutter-free workspace by minimizing the footprint of peripheral devices on the desk surface.

### Utility and Ergonomic Benefits Highlighted in FIG. 28:

This configuration directly aligns the keyboard with the user's desk layout, promoting an ergonomic workstation setup that minimizes unnecessary reach and maintains a healthy posture.

Optimized Ergonomic Alignment: Attaching the keyboard to the desk's fixture-track allows for precise positioning that can be easily modified to meet individual ergonomic requirements, thereby helping to prevent posture-related discomfort or injuries.

Space Efficiency and Accessibility: Integrating the keyboard into the desk's structure through the fixture-track optimizes the use of desk area while ensuring that the keyboard is always within easy reach, adapted to frequent adjustments depending on the task at hand.

### Conclusion for FIG. 28:

FIG. 28 effectively demonstrates the integration of the Posture-Adaptive Keyboard with a desk fixture-track FT, highlighting the practicality and ergonomic enhancements this setup provides to the standard office environment. This embodiment enhances workspace efficiency and ergonomic health by seamlessly incorporating the keyboard into the desk's existing structure, making it an ideal solution for users who value both functionality and comfort in their workstation design.

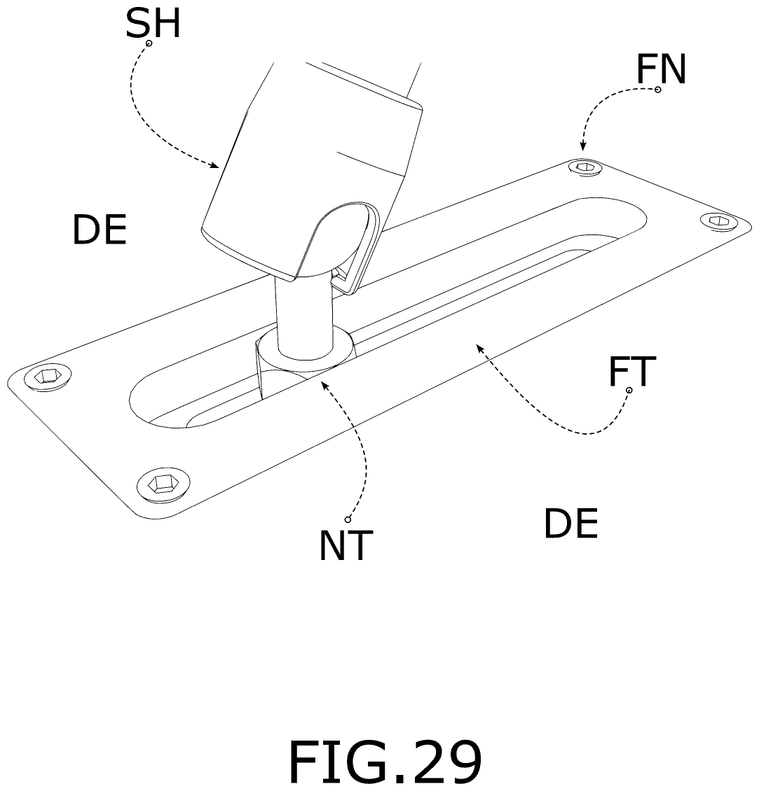

FIG. 29 is a close-up view of FIG. 28 showing where the articulated arm shoulder SH is attached to the fixture-track of a desk DE; and the top of the fasteners FN are shown, which attach the fixture-track FT to a desk DE. The fixture-track FT prevents the nut NT from turning after the Posture-Adaptive Keyboard arm is attached. An additional nut (shown in FIG. 40), or other form of fastener is used on the end of the bolt to attach the shoulder SH to the fixture-track FT of a desk DE.

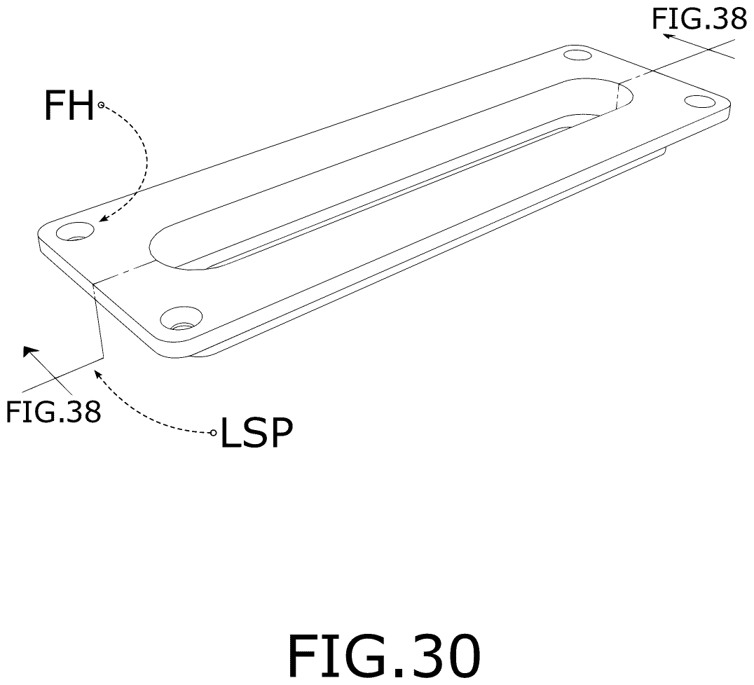

### Detailed Description Corresponding to FIG. 30 through FIG. 39

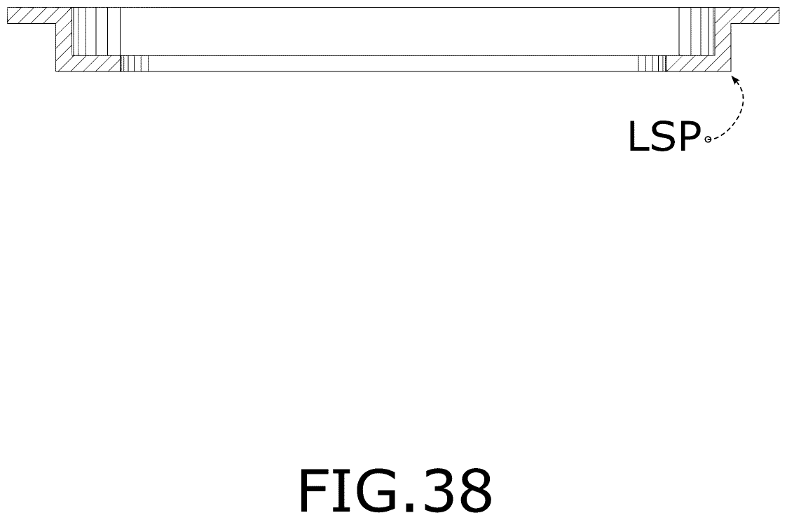

FIG. 30 is a front-top-left perspective view of a fixture-track, fastener holes FH, and a length cross-section plane LSP referenced in FIG. 38;

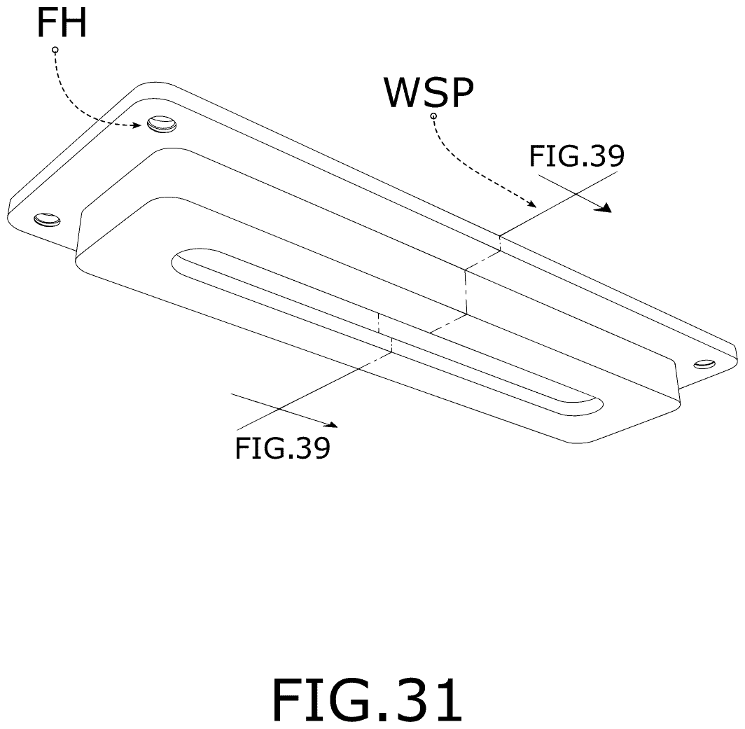

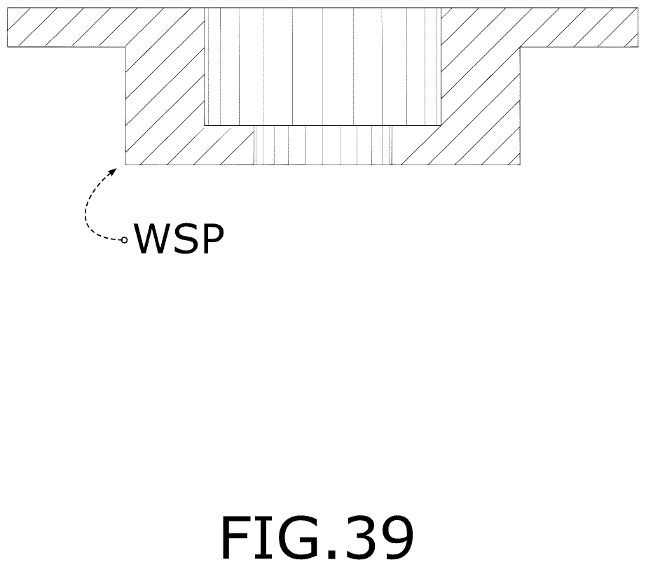

FIG. 31 is a back-bottom-right perspective view of a fixture-track, fastener holes FH, and a width cross-section plane WSP referenced in FIG. 39;

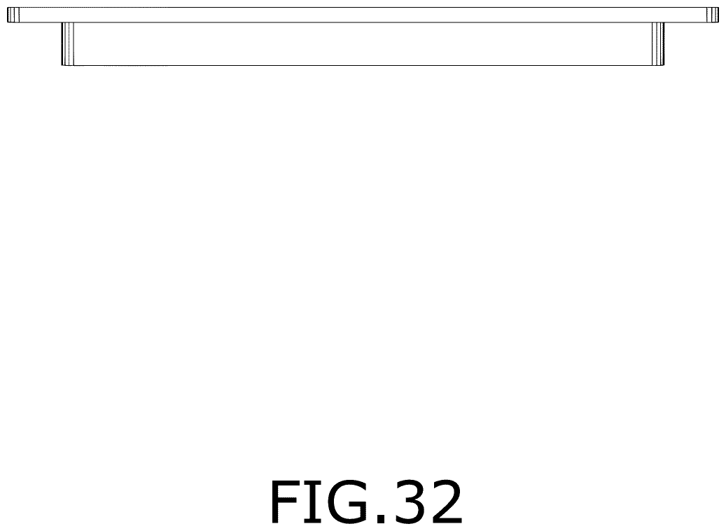

FIG. 32 is a left perspective view thereof;

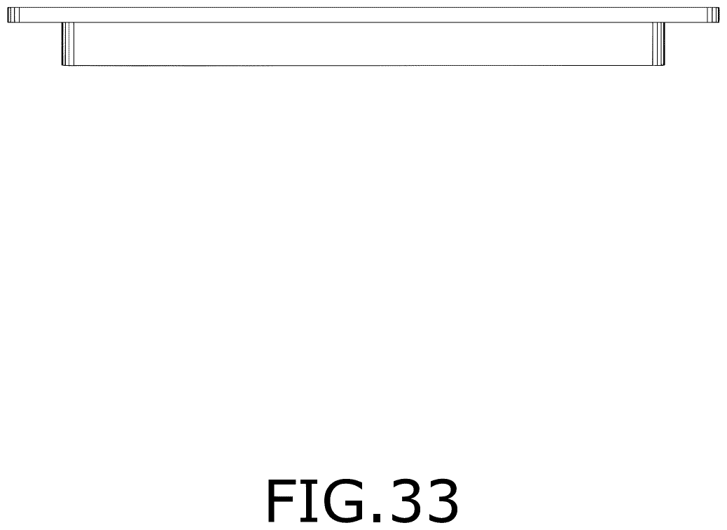

FIG. 33 is a right perspective view thereof;

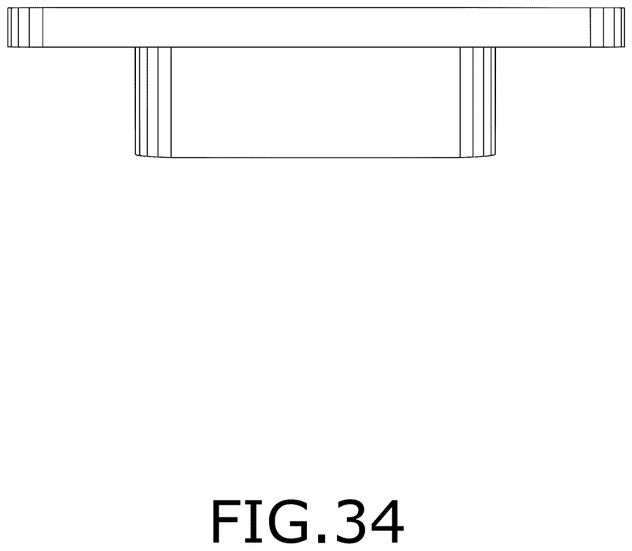

FIG. 34 is a front perspective view thereof;

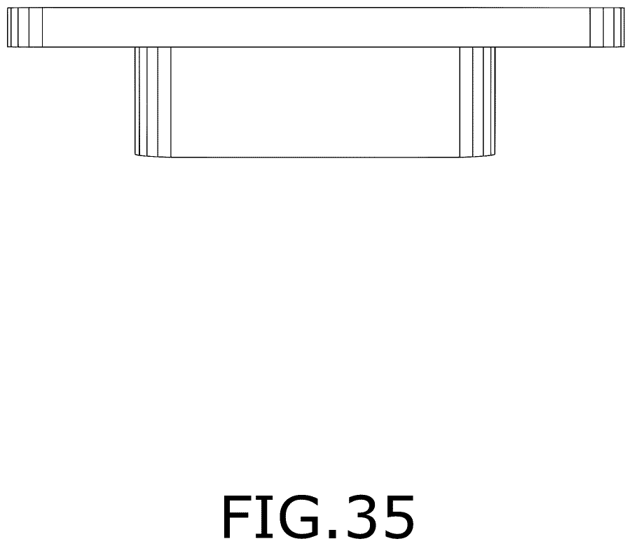

FIG. 35 is a back perspective view thereof;

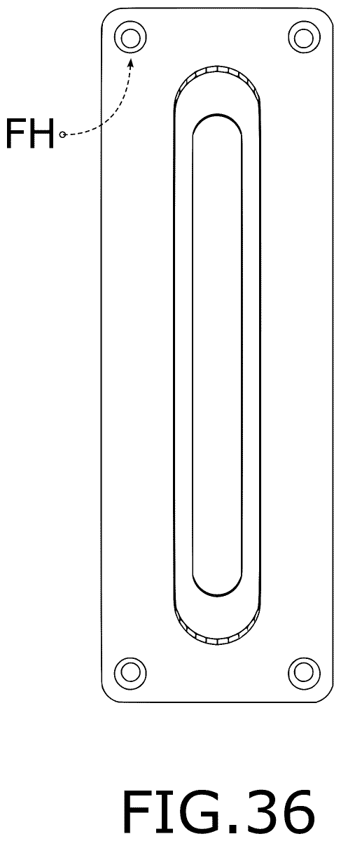

FIG. 36 is a top perspective view thereof showing fastener holes FH;

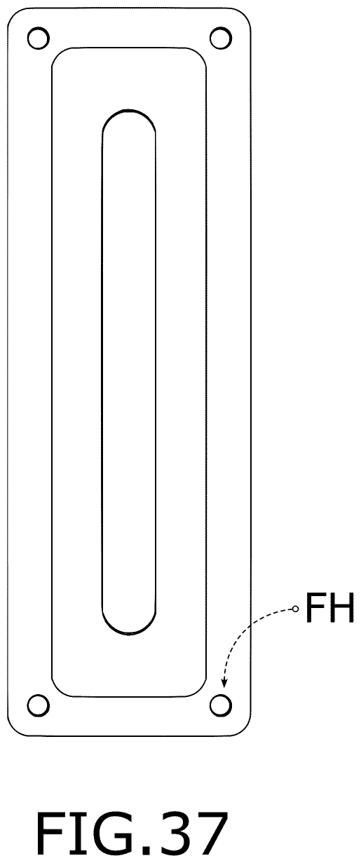

FIG. 37 is a bottom perspective view thereof showing fastener holes FH;

FIG. 38 is an orthographic view along the length cross-section plane LSP of FIG. 30 with diagonal-parallel lines indicating the length cross-section plane LSP; and

FIG. 39 is an orthographic view along the width cross-section plane WSP of FIG. 31 with diagonal-parallel lines indicating the width cross-section plane WSP.

### Detailed Description Corresponding to FIG. 40

FIG. 40 is an exploded close-up view where a Posture-Adaptive Keyboard articulated arm shoulder SH is attached to FIG. 31 showing an articulated arm bolt BL, an optional washer WS, additional nut NT2, bottom of the fasteners FN, fixture-track FT, and articulated arm shoulder SH.

The shading techniques in FIGS. 2, 8, 9, 10, 16, 17, 20, 21, 22, 23, 32, 33, 34, 35, 36, 38, 39 and on the keycaps KC, are not surface ornamentations, but are illustrative techniques for the purpose of depicting contour only and form no part of the claimed invention or of a specified embodiment thereof.

Many modifications and variations may of course be devised given the above description of preferred embodiments for implementing the principles in the present disclosure. It is intended that all such modifications and variations be considered as within the spirit and scope of this disclosure, as defined in the following claims.

1. A keyboard comprising:
an enclosure constructed from one or more materials selected from the group consisting of opaque, translucent, and transparent materials, and combinations thereof;
a mounting mechanism integrated into said enclosure, the mounting mechanism being configurable to attach to various support structures and enable multi-dimensional positioning of the keyboard including, but not limited to, adjustments along at least three axes (x-axis, y-axis, and z-axis), wherein the mounting mechanism attaches to any combination of articulating arms, flexible joints, sliding tracks, rotational bases, or extendable mounts;
wherein the adjustable positioning is facilitated by either direct manipulation of the keyboard enclosure or at least one user-operable control that adjusts the tension, angle, height, or extension of the mounting support structure to customize the keyboard orientation based on ergonomic preferences of the user.

2. The keyboard of claim 1, wherein the mounting mechanism comprises a threaded hole configured to accommodate a mounting screw of any size, ensuring stable and secure attachment to support equipment and enabling precise, customizable adjustments to the keyboard's positioning relative to the user.

3. The keyboard of claim 1, wherein the mounting mechanism comprises a threaded hole configured to accommodate a mounting screw with a size specification of ¼ inch by 20 threads per inch (¼″—20 UNC), ensuring stable and secure attachment to support equipment and enabling precise, customizable adjustments to the keyboard's positioning relative to the user.

4. The keyboard of claim 1, further comprising an articulating assembly attached to the integrated mounting mechanism, enabling multi-dimensional positional adjustments.

5. The keyboard of claim 1, further comprising a variable friction articulated arm that attaches to the integrated mounting mechanism, enabling precise, user-defined adjustment of the keyboard's position across three dimensions.

6. The keyboard of claim 4, wherein the articulating assembly includes a terminal attachment feature at its distal end, such as a clamp, magnet, suction device, or other securing mechanism, configured for reversible and secure engagement with a variety of surfaces and structural elements.

7. The keyboard of claim 4, wherein the articulating assembly further comprises a terminal clamp component at its distal end, functioning as the shoulder portion.

8. The keyboard of claim 5, wherein the variable friction articulated arm includes a terminal attachment feature at its distal end, such as a clamp, magnet, suction device, or other securing mechanism, configured for reversible and secure engagement with a variety of surfaces and structural elements.

9. The keyboard of claim 5, wherein the variable friction articulated arm further comprises a terminal clamp component at its distal end, functioning as the shoulder portion.

10. The keyboard of claim 1, further including a stand configured to support the keyboard in a raised position relative to a support surface.

11. The keyboard of claim 4, further including a stand configured to support the keyboard in a raised position relative to a support surface.

12. The keyboard of claim 5, further including a stand configured to support the keyboard in a raised position relative to a support surface.

13. The keyboard of claim 4, further comprising furniture with one or more integrated fixture-tracks, each configured to engage with the keyboard.

14. The keyboard of claim 5, further comprising furniture with one or more integrated fixture-tracks, each configured to engage with the keyboard.

15. The keyboard of claim 1, wherein the enclosure is designed during manufacturing to support a wide range of keycap positions, enabling subsequent customization with various user-selected keycap configurations and accommodating any keyboard layout including, but not limited to, QWERTY, AZERTY, and DVORAK.

16. The keyboard of claim 4, wherein the enclosure is designed during manufacturing to support a wide range of keycap positions, enabling subsequent customization with various user-selected keycap configurations and accommodating any keyboard layout including, but not limited to, QWERTY, AZERTY, and DVORAK.

17. The keyboard of claim 5, wherein the enclosure is designed during manufacturing to support a wide range of keycap positions, enabling subsequent customization with various user-selected keycap configurations and accommodating any keyboard layout including, but not limited to, QWERTY, AZERTY, and DVORAK.
